(19) United States
(12) Patent Application Publication
(10) Pub. No.: US 2017/0316747 A1
(43) Pub. Date: Nov. 2, 2017

(54) DISPLAY APPARATUS

(71) Applicant: NLT Technologies, Ltd., Kanagawa (JP)

(72) Inventor: Yojiro MATSUEDA, Kanagawa (JP)

(21) Appl. No.: 15/493,458

(22) Filed: Apr. 21, 2017

(30) Foreign Application Priority Data
Apr. 28, 2016 (JP) 2016-091219

(51) Int. Cl. G09G 3/36

(52) U.S. Cl. CPC G09G 3/3607; G09G 3/3614; G09G 2320/0247; G09G 2310/0297

(57) ABSTRACT

A display apparatus suppresses flicker, and includes a display part in which a first plurality of main pixels PX1 to PX4 including subpixels R1 to R4, G1 to G4 and B1 to B4 of a first to an N-th color are arrayed in a line, the “N” being an integer larger than 1; and a demultiplexer including distribution units 41-46 distributing a drive signal CKH, driving any one of a plurality of subpixels included in a subpixel group to the one of the plurality of subpixels. The subpixel group includes multiple subpixels SPX1 and SPX2 included in a second plurality of main pixels PX1 and PX3 among the first plurality of main pixels, one or more main pixels being interposed between the second plurality of main pixels, the subpixels SPX1 and SPX 2 being subpixels having the same color to which drive signals of the same polarity are input.

This non-provisional application claims priority under 35 U.S.C.§119(a) on Patent Application No. 2016-091219 filed in Japan on Apr. 28, 2016, the entire contents of which are hereby incorporated by reference.

### FIELD

The present disclosure relates to a display apparatus.

### BACKGROUND

A display apparatus comprises a display panel on which an image is displayed. The display panel is driven by a driver circuit so that an image is displayed on a display surface. A display apparatus has been proposed in which the number of output terminals of a driver integrated circuit (IC) is reduced by employing a demultiplexer in the driver circuit. Such a display apparatus is disclosed in Japanese Patent Application Laid-Open Publication No. 2004-170767, for example.

In the case where a demultiplexer is employed, the output terminals of the driver IC are respectively corresponding with multiple pixels selected at the same time in one scanning period. Drive signals for the respective pixels are divided by time and output through the output terminals. The demultiplexer distributes the drive signals to the pixels. This shortens the input time for the drive signals distributed to the respective pixels. The shorter input time for the drive signals may cause a shortage of voltage to be applied to the pixels. For example, it may be possible that a voltage depending on the gradation level of a pixel is not applied to the pixel. The shortage of voltage causes deterioration in image quality. In the description below, the shortage of voltage to be applied to a pixel will also be referred to as a voltage shortage. Moreover, the application of voltage to a pixel is also called writing, and thus the voltage shortage is also referred to as writing insufficiency.

### SUMMARY

A display apparatus according to an aspect of the present disclosure includes: a display unit in which a first plurality of main pixels including subpixels of a first color to an N-th color are arrayed in a line, “N” being an integer larger than 1; and a demultiplexer including a distribution unit configured to distribute a drive signal which drives any one of a plurality of subpixels included in a subpixcel group to the one of the plurality of subpixels. The subpixel group includes a plurality of subpixels included in a second plurality of main pixels among the first plurality of main pixels, one or more main pixels being interposed between the second plurality of main pixels, the plurality of subpixels being subpixels having a same color to which drive signals of the same polarity are input.

The above and further objects and features will more fully be apparent from the following detailed description with accompanying drawings.

It is to be understood that both the foregoing general description and the following detailed description are exemplary and explanatory and are not restrictive of this disclosure.

### BRIEF DESCRIPTION OF THE DRAWINGS

FIG. 1 is an exploded perspective view illustrating a configuration of a liquid crystal display apparatus;

FIG. 2 illustrates the configuration of a liquid crystal panel;

FIG. 3 is a block diagram illustrating a configuration of a driver IC;

FIG. 4 illustrates a method of distributing drive signals using a demultiplexer in a related art;

FIG. 5 is a timing chart illustrating an example of a drive waveform for a pixel circuit;

FIG. 6 illustrates an example of a pixel configuration of a liquid crystal panel;

FIG. 7 illustrates an example of a check pattern;

FIG. 8 illustrates an example of a check pattern;

FIG. 9 illustrates an example of a check pattern;

FIG. 10A illustrates control performed when a Pixel Check pattern is displayed;

FIG. 10B illustrates control performed when a Pixel Check pattern is displayed;

FIG. 10C illustrates control performed when a Pixel Check pattern is displayed;

FIG. 11 is a timing chart illustrating an example of a voltage shortage;

FIG. 12A illustrates control performed when a 1×1 Bar pattern and a Dot Check pattern are displayed;

FIG. 12B illustrates control performed when a 1×1 Bar pattern and a Dot Check pattern are displayed;

FIG. 12C illustrates control performed when a 1×1 Bar pattern and a Dot Check pattern are displayed;

FIG. 13 illustrates an example of a pitch conversion wiring part;

FIG. 14 illustrates an equivalent circuit of the pitch conversion wiring part;

FIG. 15 illustrates a configuration of a demultiplexer according to Embodiment 1;

FIG. 16 illustrates a configuration of a first distribution unit;

FIG. 17 illustrates a configuration of a demultiplexer;

FIG. 18A illustrates control performed when a Pixel Check pattern is displayed;

FIG. 18B illustrates control performed when a Pixel Check pattern is displayed;

FIG. 18C illustrates control performed when a Pixel Check pattern is displayed;

FIG. 19 is a timing chart illustrating a drive waveform;

FIG. 20A illustrates control performed when the 1×1 Bar pattern and the Dot Check pattern are displayed;

FIG. 20B illustrates control performed when the 1×1 Bar pattern and the Dot Check pattern are displayed;

FIG. 20C illustrates control performed when the 1×1 Bar pattern and the Dot Check pattern are displayed;

FIG. 21 illustrates a configuration of a demultiplexer;

FIG. 22A illustrates control performed when the Pixel Check pattern is displayed;

FIG. 22B illustrates control performed when the Pixel Check pattern is displayed;

FIG. 22C illustrates control performed when the Pixel Check pattern is displayed;

FIG. 23A is a time chart illustrating drive timing of a demultiplexer;

FIG. 23B is a time chart illustrating drive timing of a demultiplexer;

FIG. 24A is a time chart illustrating drive timing of a demultiplexer;

FIG. 24B is a time chart illustrating drive timing of a demultiplexer;

FIG. 25 illustrates another configuration of a demultiplexer;

FIG. 26 illustrates a configuration of a first distribution unit; and

FIG. 27A illustrates an association between a demultiplexer and subpixels;

FIG. 27B illustrates an association between a demultiplexer and subpixels.

### DETAILED DESCRIPTION

### Embodiment 1

Embodiments will be described below in detail with reference to the drawings. The ordinal numbers such as “first,” “second” and the like in the specification and claims are denoted to clarify the relationship between elements and to prevent confusion between elements. These ordinal numbers are therefore not to limit the number of elements.

Moreover, the term “connect” means that to-be-connected elements are electrically connected with each other. The term “electrically connect” also includes the connection between the to-be-connected elements via an electric element such as an electrode, a wiring, a resistance, a capacitor or the like. It is noted that the terms “electrode,” “wiring” and “terminal” functionally limit these components. For example, the “terminal” and “wiring” may also be used as a part of the “electrode.” Moreover, the “electrode and “terminal” may also be used as a part of the “wiring.” Alternatively, the “electrode” and “wiring” may also be used as a part of the “terminal.”

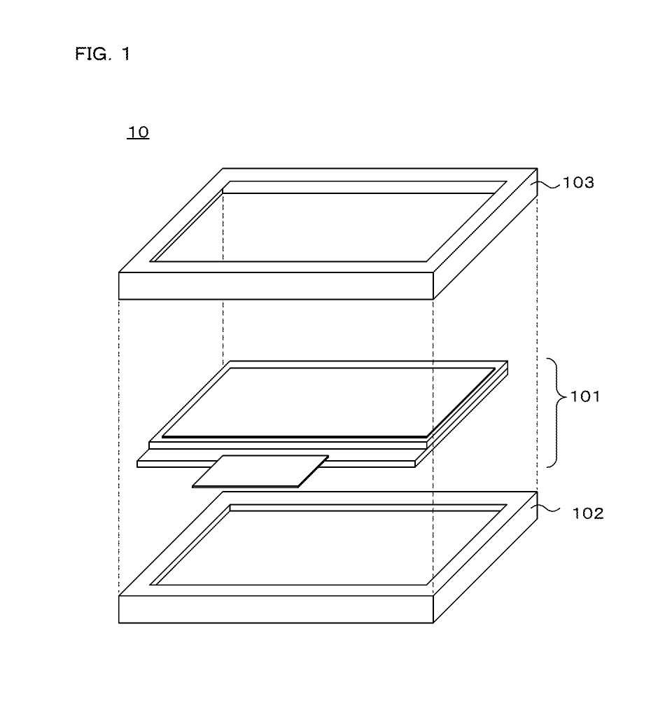

In the description below, a liquid crystal display apparatus comprising a liquid crystal display (LCD) panel is described as an example of a display apparatus. FIG. 1 is an exploded perspective view illustrating a configuration of a liquid crystal display apparatus 10. The liquid crystal display apparatus 10 includes a liquid crystal panel 101, a backlight unit 102 and a bezel 103. The configuration of the liquid crystal panel 101 will be described later. The backlight unit 102 supplies planar light. The bezel 103 forms the shape of a frame. The bezel 103 covers the periphery of the liquid crystal panel 101. The bezel 103 is assembled to the backlight unit 102. The planar light from the backlight unit 102 is directed to a rear surface of the liquid crystal panel 101. The liquid crystal panel 101 controls the light to display an image on a front surface.

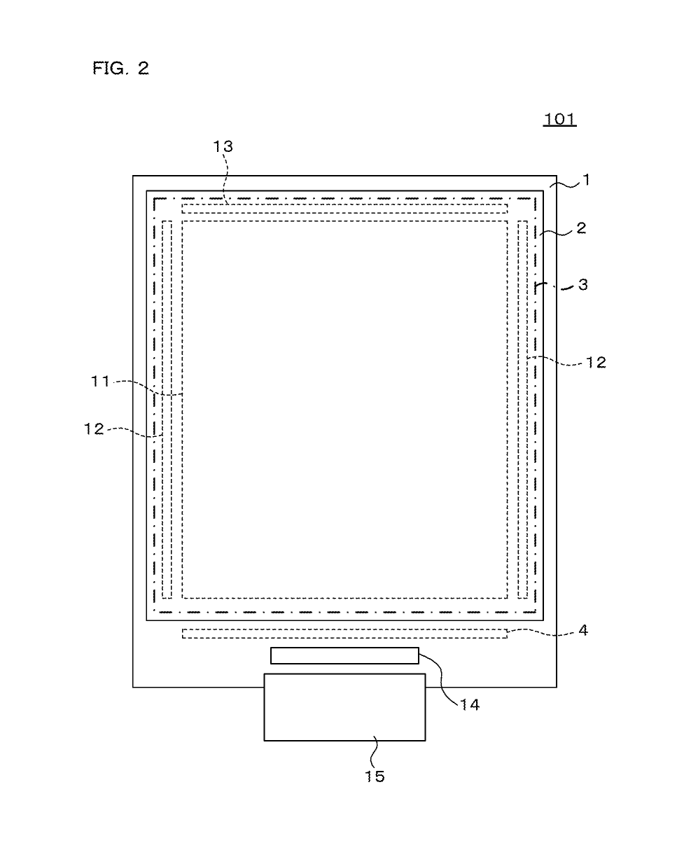

FIG. 2 illustrates a configuration of the liquid crystal panel 101. The liquid crystal panel 101 includes a thin film transistor (TFT) substrate 1, a color filter substrate 2 and a seal part 3.

Multiple pixel circuits are arrayed in matrix on the TFT substrate 1. A color filter element and a black matrix are arrayed on the color filter substrate 2. The seal part 3 bonds the TFT substrate 1 to the color filter substrate 2. Liquid crystal is disposed between the TFT substrate 1 and the color filter substrate 2.

On the TFT substrate 1, scanning drivers 12, a data line electro-static-discharge (ESD) protection circuit 13, a demultiplexer 4 and a driver integrated circuit (IC) 14 are disposed. Furthermore, one end of a flexible printed circuit (FPC) 15 is connected to the TFT substrate 1.

The scanning drivers 12 are located at the outer right and left sides, respectively, of the active matrix part 11 on the TFT substrate 1. The scanning drivers 12 drive scanning lines. The data line ESD protection circuit 13 prevents a damage caused by electrostatic discharge. The driver IC 14 supplies a drive signal for driving pixels to the demultiplexer 4. The liquid crystal in a pixel is controlled for its orientation based on the drive signal. Note that the pixel here indicates a subpixel which will be described later.

The demultiplexer 4 distributes the drive signals supplied from the driver IC to the pixels connected to data lines. The driver IC 14 is mounted to the TFT substrate 1 with the use of an anisotropic conductive film. The TFT substrate 1 is connected to external equipment via the FPC 15.

The liquid crystal panel 101 includes, for example, main pixels arrayed in Y rows and X columns (each of Y and X is an integer equal to or larger than 1). Each subpixel displays one color based on the color filter substrate 2. Each of the main pixels includes subpixels of the first color to the N-th color (N is an integer larger than 1). Here, N=3. The first color is red. The second color is green. The third color is blue. A pixel circuit is provided to correspond to each subpixel.

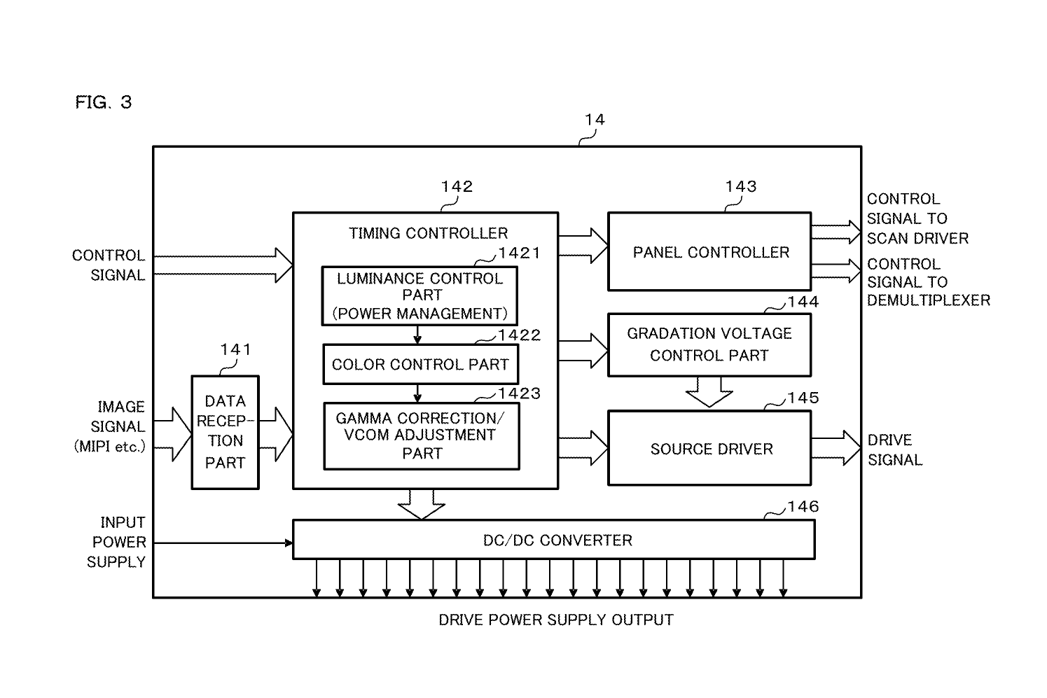

FIG. 3 is a block diagram illustrating a configuration of the driver IC 14. The driver IC 14 includes a data reception part 141, a timing controller 142, a panel controller 143, a gradation voltage control part 144, a source driver 145 and a DC/DC converter 146.

The data reception part 141 receives an image signal from an external device. For example, an image signal is a signal according to the Mobile Industry Processor Interface (MIDI, registered trademark) standard. The timing controller 142 receives control signals from an external device. The control signals are, for example, a horizontal synchronizing signal and a vertical synchronizing signal. The timing controller 142 includes a luminance control part 1421, a color control part 1422 and a gamma correction/VCOM adjustment part 1423. The luminance control part 1421 obtains a luminance value of each pixel based on an image signal. The color control part 1422 obtains a luminance value of each subpixel based on a luminance value. The gamma correction/VCOM adjustment part 1423 performs gamma correction. Moreover, the gamma correction/VCOM adjustment part 1423 corrects voltage applied to a common electrode. The panel controller 143 outputs a control signal to the scanning driver 12 and a control signal to the demultiplexer 4, based on a horizontal synchronizing signal. The gradation voltage control part 144 replaces the luminance value of each subpixel with a gradation value, and outputs voltage depending on the gradation value to the source driver 145. The source driver 145 generates a drive signal based on the voltage obtained from the gradation voltage control part 144 and the vertical synchronizing signal, and outputs the drive signal to the demultiplexer 4. The DC/DC converter 146 supplies power to its own or other components based on the input power from an external source. Moreover, the DC/DC converter 146 supplies a voltage VCOM to be applied to a common electrode to a pixel circuit.

The liquid crystal display apparatus 10 includes a display unit, a control circuit and a driver circuit. The display unit is, for example, the liquid crystal panel 101. The liquid crystal panel 101 is a liquid crystal cell device which includes two glass substrates, a TFT substrate and a counter glass substrate. The control circuit is, for example, a panel controller 143. The driver circuit is, for example, a source driver 145. All function of the source driver 145 is integrated in the driver IC 14. The panel controller 143 function not only may be integrated in the driver IC 14 but also may be achieved in the other IC such as a power supply controlling IC in order to pursuit the efficiency of the DC/DC converting function.

Next, the demultiplexer will be described. In the related art, the number of data lines have increased due to the advancement of a highly precise liquid crystal panel. Accordingly, it is necessary to increase the number of output terminals of the driver IC which drives data lines. However, there is limitation in the space where the driver IC is disposed because of the requirement for a display apparatus to have a narrowing frame and a reduced size. It is thus difficult to provide output terminals of the driver IC in the number corresponding to the number of data lines. That is, it is difficult to have the output terminals of the driver IC and the data lines in one-to-one correspondence. Thus, a demultiplexer is disposed between the driver IC and the data line. The demultiplexer allows the number of output terminals of the driver IC to be smaller than the number of data lines.

The demultiplexer is a circuit for distributing input signals input through one input terminal to any one of the output terminals. Such a demultiplexer is also present that has multiple sets of terminals, each set including one input terminal and multiple output terminals corresponding thereto. A demultiplexer is configured by an analog switch using a TFT. The demultiplexer distributes input signals by switching this analog switch. Switching of the analog switch is performed based on a control signal. The demultiplexer may drive data lines corresponding to n times the number of output terminals of the drive IC by switching the output of the driver IC through the analog switch n times during the scanning period.

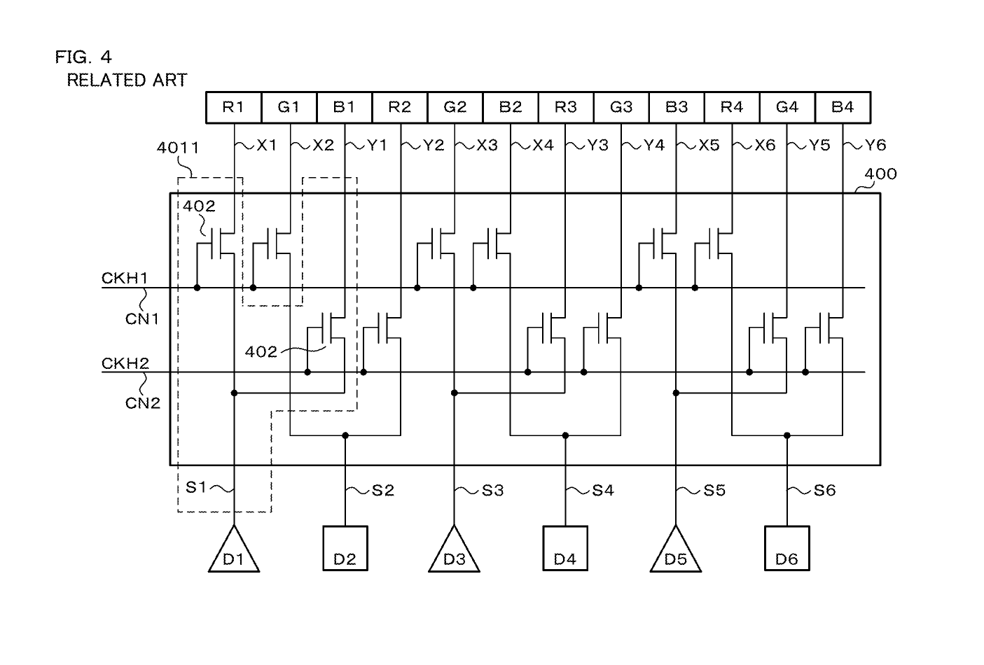

Next, a demultiplexer in a related art will be described. FIG. 4 illustrates a method of distributing drive signals using the demultiplexer in the related art. A demultiplexer 400 includes six input terminals S1 to S6, twelve output terminals X1 to X6 and Y1 to Y6, and two control signal terminals CN1 and CN2. D1 to D6 respectively represent drive signals to be input to the input terminals S1 to S6. Since the demultiplexer 400 has six input terminals and twelve output terminals, it is a 6-to-12 demultiplexer. The demultiplexer 400 controls the distributing operation based on control signals CKH1 and CKH2 input to control signal terminals CN1 and CN2, respectively.

The demultiplexer 400 includes distribution units 401n (n is an integer from 1 to 6) distributing signals input to an input terminal Sn to output terminals Xn or Yn. Each of the distribution units 401n includes two switching elements 402. The switching elements 402 are controlled by the control signal CKH1 or CKH2. When the control signal CKH1 is active, one of the two switching elements is turned on. When the control signal CKH2 is active, the other one of the two switching elements is turned on. In FIG. 4, the distribution unit 4011 is enclosed by a line. The distribution unit 4011 distributes the signal input from the input terminal S1 to the output terminal X1 when the control signal CKH1 is active. The distribution unit 4011 distributes the signal input from the input terminal S1 to the output terminal Y1 when the control signal CKH2 is active. The distribution units 4012 to 4016 operate similarly to the distribution unit 4011. Moreover, it is not assumed here that the control signals CKH1 and CKH2 are both active.

The operation of distributing drive signals in FIG. 4 will now be described. Liquid crystal is generally driven by AC Voltage, symmetric positive and negative data signal. Thus, in consideration of the symmetry of the positive and negative voltage, connection is made such that the voltage to be applied to the pixels has a uniform polarity. In the liquid crystal display, polarities are inverted between adjacent subpixels (data lines are inverted) for driving in order to prevent decrease in the image quality. An example of decrease in the image quality includes a so-called flicker. As such, signals of the same polarity are paired and 2×3 or 3×2 sets of the pairs are used.

FIG. 4 illustrates two 2×3 sets. In FIG. 4, drive signals input to the input terminals S1 to S6 are categorized into two by triangles and squares. The drive signals of the same figure indicate that they have the same polarity. The drive signals of different figures indicate that they have different polarities. The drive signals D1, D3 and D5 are indicated as having the same polarity. The drive signals D2, D4 and D6 are indicated as having the same polarity. Moreover, the drive signals D1, D3 and D5 have a polarity different from that of the drive signals D2, D4 and D6.

R1 to R4, G1 to G4 and B1 to B4 connected to the output terminals X1 to X6 and Y1 to Y6 represent subpixels. The alphabet indicates the color of a subpixel. R1 to R4 represent the subpixels of red. G1 to G4 represent the subpixels of green. B1 to B4 represent the subpixels of blue. The numbers are to identify the main pixel which includes the subpixel. The subpixels with the same number indicate that they are included in the same main pixel. For example, R1, G1 and B1 are included in the same pixel.

The demultiplexer 400 illustrated in FIG. 4 so operates that signals of different polarities are applied respectively to adjacent subpixels. For example, it is assumed that the drive signals D1, D3 and D5 are signals with a positive polarity. Here, the drive signals D2, D4 and D6 are signals with a negative polarity. When the control signal CKH1 is active, the drive signal D1 is distributed to the subpixel R1. The drive signal D2 is distributed to the subpixel G1. The drive signal D3 is distributed to the subpixel G2. The drive signal D4 is distributed to the subpixel B2. The drive signal D5 is distributed to the subpixel B3. The drive signal D6 is distributed to the subpixel R4.

When the control signal CKH2 is active, the drive signal D1 is distributed to the subpixel B1. The drive signal D2 is distributed to the subpixel R2. The drive signal D3 is distributed to the subpixel R3. The drive signal D4 is distributed to the subpixel G3. The drive signal D5 is distributed to the subpixel G4. The drive signal D6 is distributed to the subpixel B4. In voltage applications twice, the polarities of the voltage applied to the subpixels are as follows when indicated in sequence from left. Positive, negative, positive, negative, positive, negative, positive, negative, positive, negative, positive, negative. As such, in the related art also, the demultiplexer 400 is used to implement the operation of applying signals of different polarities respectively to adjacent subpixels.

With the use of the demultiplexer, however, a shortage of voltage is likely to occur. In the case of using the demultiplexer 400 as described above, one scanning period is divided into two and drive signals are applied in sequence to two subpixels. Thus, compared to the case of not using a demultiplexer, the time for applying drive signals to subpixels is reduced to approximately half. If the time for applying drive signals is shortened, it is more likely that a shortage of voltage occurs by the amount corresponding to the shortened time. The shortage of voltage in the demultiplexer then causes a defect as described below.

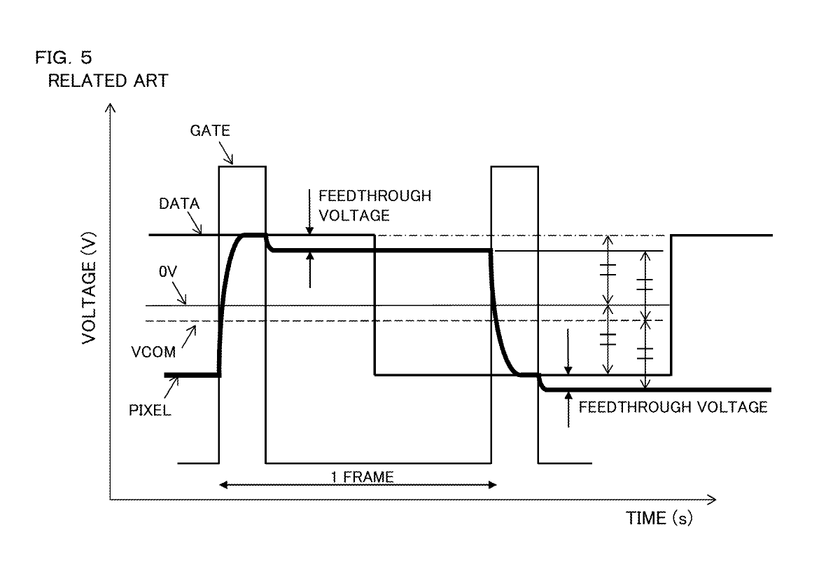

FIG. 5 is a timing chart illustrating an example of a drive waveform in a pixel circuit. The horizontal axis indicates time, while employing the unit of seconds (s). The vertical axis indicates voltage, while employing the unit of volt (V). The waveform denoted as “gate” represents a gate signal. The waveform denoted as “data” represents a drive signal. The waveform denoted as “Pixel” represents a potential of a pixel electrode. VCOM is a common electrode or an opposite electrode, which is an electrode holding voltage between itself and the pixel electrode. The waveform denoted as “VCOM” represents the potential of this VCOM. To the Pixel, in the chart of FIG. 5, a positive voltage is written after rising of the initial gate signal, and a negative voltage is written at the rising of the next gate signal. As illustrated in FIG. 5, VCOM and the drive signal have a difference in a direct current (DC) component by the amount corresponding to feedthrough voltage caused by TFT constituting the pixel circuit.

The feedthrough voltage is dependent on the capacity ratio of the parasitic capacitance of TFT to the sum of the retention capacitance and liquid crystal capacitance. More specifically, if the voltage of the drive signal is different, the feedthrough voltage may also be different due to the dielectric anisotropy of liquid crystal. More specifically, as the voltage difference between the first drive signal and the second drive signal that are applied in sequence to the subpixels is increased, the difference in the feedthrough voltage is also increased. It is noted that the first drive signal has, for example, voltage corresponding to black, whereas the second drive signal has voltage corresponding to white.

Moreover, as the parasitic capacitance of TFT varies depending on the gate voltage, the feedthrough voltage is different if the drive signals with the same absolute value of voltage have different polarities. For example, even if the eleventh drive signal and the twelfth drive signal applied in sequence to the subpixels have the same voltage, the feedthrough voltage is different if they have different polarities.

As such, if the drive signals having different polarities and a large voltage difference are sequentially applied to the pixels, the difference in the feedthrough voltage is increased, and such a difference in the feedthrough voltage is observed as a flicker (polarity-asymmetric component). The shortage of voltage by the demultiplexer facilitates the difference, thereby worsening the flicker. It is thus required for the demultiplexer to have such a drive condition as to generate no shortage of voltage.

Meanwhile, the liquid crystal display apparatus is verified for any problem in the display performance at the time of product shipment using a predetermined image pattern referred to as a check pattern. It is particularly required for the liquid crystal display apparatus to generate no flickers in the case where the check pattern is displayed.

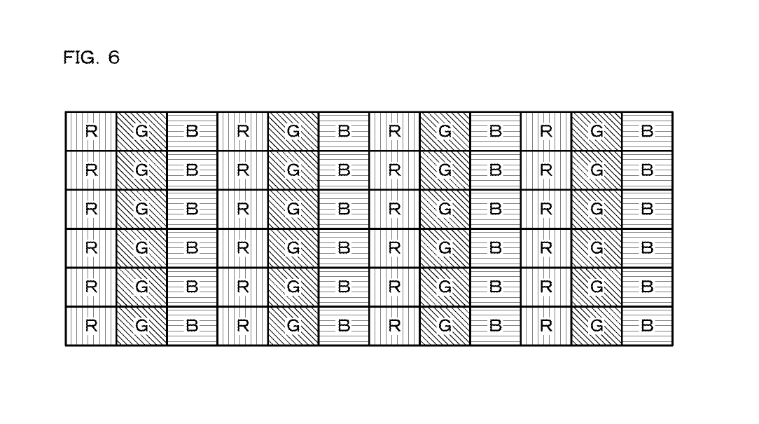

The check pattern and the application of drive signals at the time of displaying the check pattern will now be described. FIG. 6 illustrates an example of a pixel configuration of a liquid crystal panel. The pixel configuration illustrated in FIG. 6 includes six rows and four columns, which is a variation of the configuration of one row and four columns illustrated in FIG. 4. In the description below, the operation at the liquid crystal display apparatus having the pixel configuration illustrated in FIG. 6 will be described.

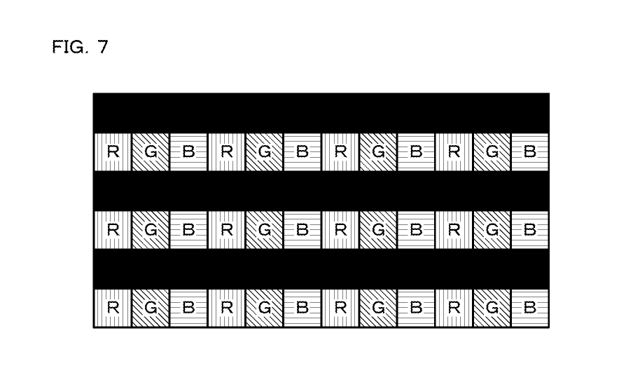

FIGS. 7 to 9 illustrate examples of check patterns. FIG. 7 illustrates a check pattern called a 1×1 Bar pattern. The 1×1 Bar pattern is a pattern with an alternate repetition of a black row and a white row. In the example illustrated in FIG. 7, the odd rows are black whereas the even rows are white.

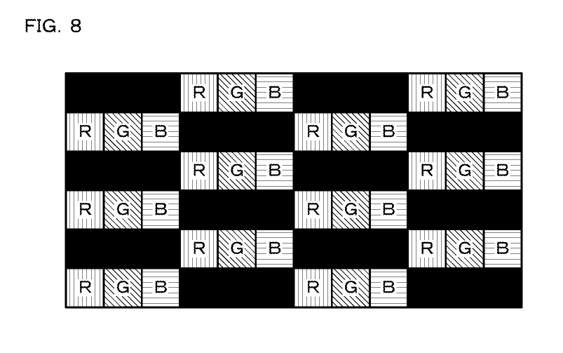

FIG. 8 illustrates a check pattern called a Pixel Check pattern. The Pixel Check pattern is a pattern in which black, white, black and white are repeated for the respective main pixels adjacent to each other in the left-right direction. In the Pixel Check pattern, the main pixels adjacent to each other in the up-down direction also have the repetition of black, white, black and white. That is, if an odd row shows white, black, white and black, an even row shows black, white, black and white.

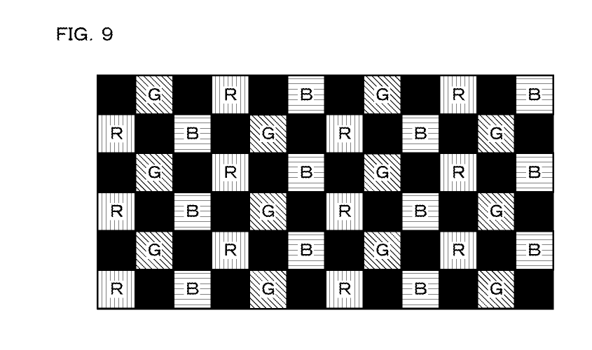

FIG. 9 illustrates a check pattern called a Dot Check pattern. The Dot Check pattern is a pattern in which black, white, black and white are repeated for the respective subpixels adjacent to each other in the left-right direction. In the Dot Check pattern, the subpixels adjacent to each other in the up-down direction also have the repetition of black, white, black and white.

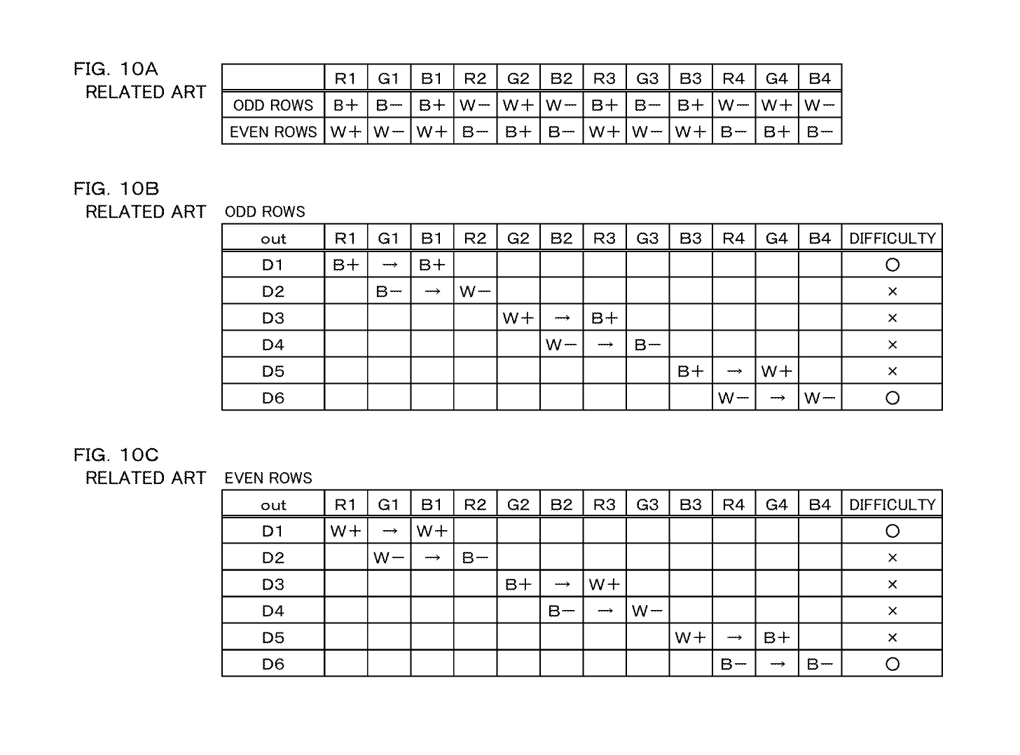

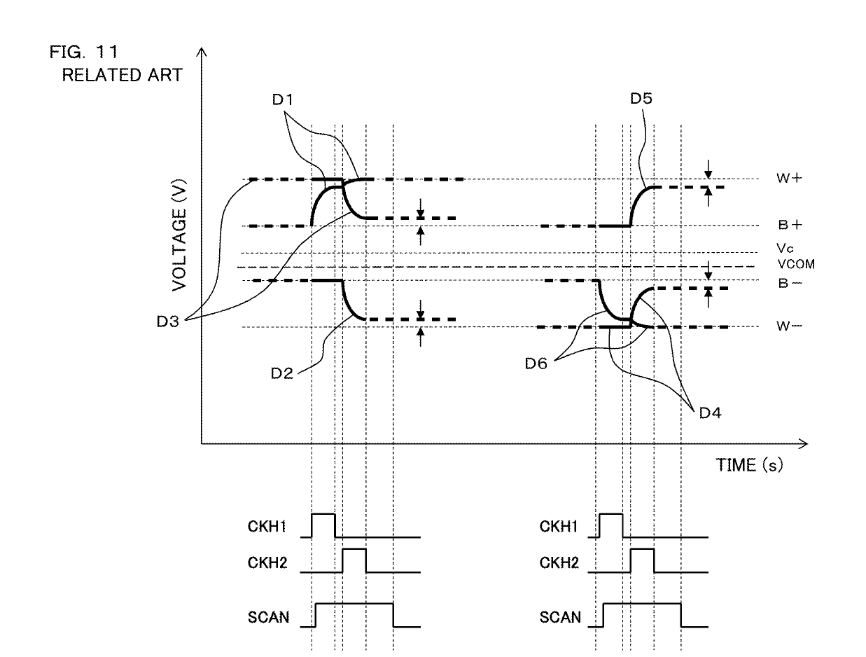

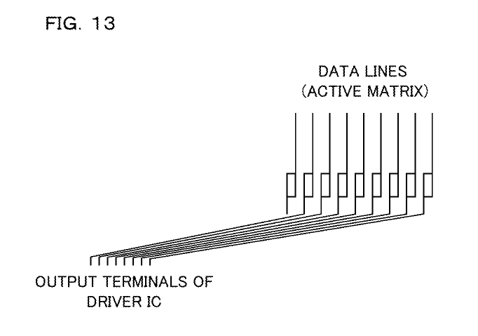

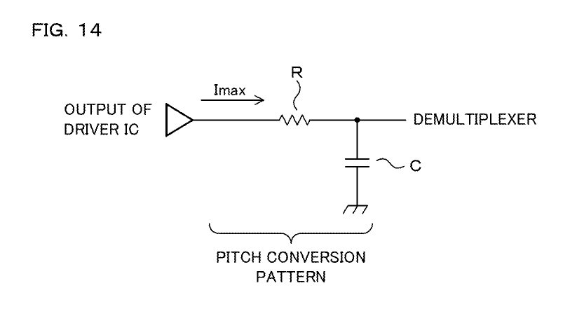

Next, a voltage shortage occurring in the liquid crystal display apparatus employing the demultiplexer 400 in the related art will be described. First, a specific example of the voltage shortage is described with reference to FIGS. 10 and 11. Then, a cause of generating the voltage shortage is described with reference to FIGS. 13 and 14.

FIGS. 10A-10C illustrates control performed when the Pixel Check pattern is displayed. FIG. 10A illustrates details of the control for each subpixel in the case where the Pixel Check pattern is displayed. FIG. 10B illustrates application of drive signals to subpixels in the odd rows. FIG. 10C illustrates the order of application to subpixels in the even rows. R1 to R4, G1 to G4 and B1 to B4 illustrated in FIGS. 10A-10C represent subpixels. B+, B−, W+ and W− represent drive signals to be applied to the subpixels. B+ represents positive black. B− represents negative black. W+ represents positive white. W− represents negative white. In FIGS. 10B and 10C, D1 to D6 represent drive signals. FIG. 10A illustrates drive signals to be applied to the respective subpixels in the case where the Pixel Check pattern illustrated in FIG. 8 is displayed. As described above, each of the distribution units 401n in the demultiplexer 400 according to the related art divides one scanning period into two, and sequentially applies drive signals to two subpixels. The application in the first half of one scanning period is referred to as the first application or simply as the first time. The application in the last half of one scanning period is referred to as the second application or simply as the second time. For the drive signals D1 to D6 input to the demultiplexer 400, the distribution units 401n apply drive signals to different subpixels at the first time and the second time, respectively. FIGS. 10B and 10C illustrate the subpixels to which the drive signals D1 to D6 are applied at the first time, and the subpixels to which the drive signals D1 to D6 are applied at the second time, respectively. That is, in each row corresponding to each of the drive signals D1 to D6, two columns are filled with drive signals. In FIGS. 10B and 10C, an arrow put between the two columns filled with drive signals in each row indicates the order of application of the drive signals. For example, FIG. 10B shows that, in the writing to the odd rows, the drive signal D1 causes B+ to be applied to the subpixel R1 at the first time and B+ to be applied to the subpixel B1 at the second time. The column under “difficulty” in FIGS. 10B and 10C indicates the difficulty of application to the subpixels at the second time. The case where no shortage of voltage occurs at the second time is regarded as easy and is indicated as O, while the case where a shortage of voltage occurs at the second time is regarded as difficult and is indicated as X.

FIG. 11 is a timing chart illustrating an example of voltage shortage. FIG. 11 illustrates the application operation of drive signals for the odd rows in the liquid crystal panel in the case where the Pixel Check pattern in displayed. In the upper chart of FIG. 11, the horizontal axis indicates time. The unit of seconds (s) is employed. In the upper chart of FIG. 11, the vertical axis indicates potential. The unit of (V) is employed. In the upper chart of FIG. 11, Vc represents the potential at the center of data. VCOM represents the potential at a common electrode or an opposite electrode. W+ represents the potential of positive white. B+ represents the potential of positive black. B− represents the potential of negative black. W− represents the potential of negative white. The lower part of FIG. 11 illustrates a chart showing the change with time for the control signals CKH1 and CKH2 input to the demultiplexer. Moreover, SCAN is a scanning signal. The control signals CKH1 and CKH2 as well as the scanning signal SCAN correspond to a positive logic (high active).

FIG. 11 illustrates the operation as shown in FIG. 10B by a timing chart. The drive signal D1 applies B+ at the first time and B+ at the second time. Such application causes a shortage of voltage at the first time but not at the second time. The drive signal D2 applies B− at the first time and W− at the second time. Such application causes a shortage of voltage at the second time. The drive signal D3 applies W+ at the first time and B+ at the second time. Such application causes a shortage of voltage at the second time. The drive signal D4 applies W− at the first time and B− at the second time. Such application causes a shortage of voltage at the second time. The drive signal D5 applies B+ at the first time and W+ at the second time. Such writing causes a shortage of voltage at the second time. The drive signal D6 applies W− at the first time and W− at the second time. Such application causes a shortage of voltage at the first time but not at the second time. Considering the application to the even rows similarly to the odd rows, a result shown in FIG. 10C is obtained.

As described above, in the case where the demultiplexer 400 according to the related art is used, a shortage of voltage occurs at the time of the Pixel Check pattern often used in flicker measurement or the like is displayed. As the shortage of voltage occurs, a direct current component is applied to liquid crystal. This causes a problem of increased flickers. The shortage of voltage also causes a problem of decreased contrast.

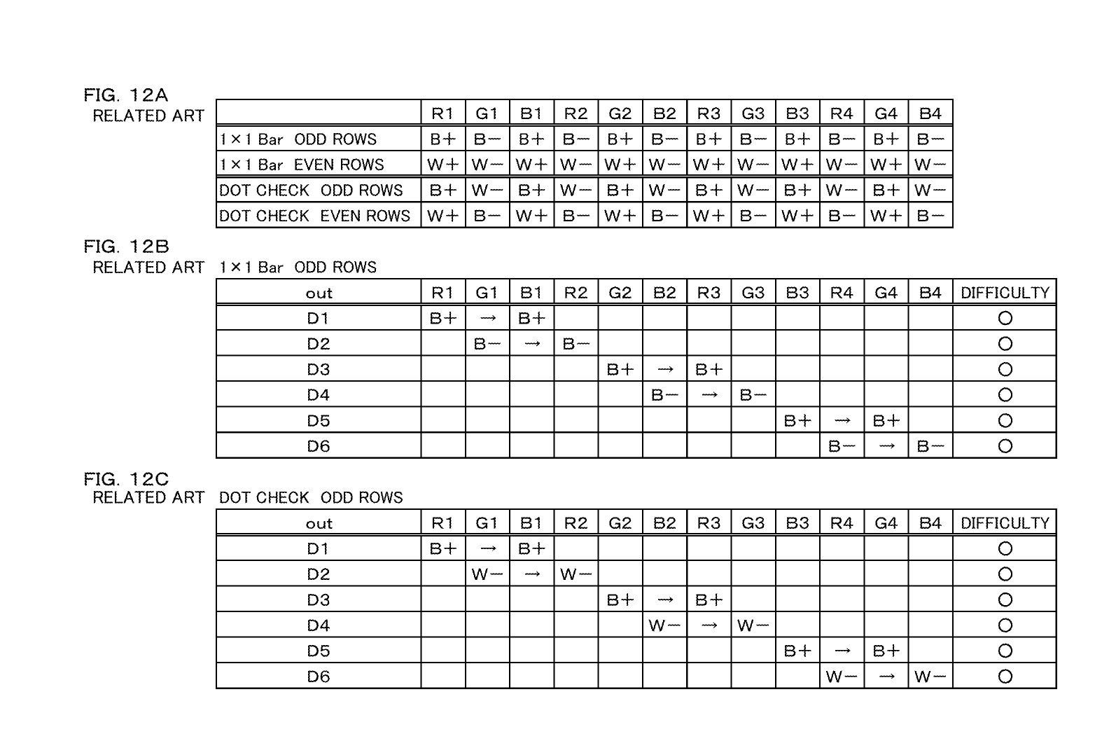

Patterns other than the Pixel Check pattern is now discussed. FIGS. 12A-12C illustrates control performed when the 1×1 Bar pattern and a Dot Check pattern are displayed. FIG. 12A illustrates details of the control for each subpixel in the case where the two patterns are displayed. FIG. 12B illustrates the order of writing to the subpixels in the odd rows in the 1×1 Bar pattern. FIG. 12C illustrates the order of writing to the subpixels in the odd rows in the Dot Check pattern. In FIGS. 12A-12C, the form of expressing the subpixels, the drive signals to be applied or the like is similar to that in FIGS. 10A-10C, and thus will not be described. As illustrated in FIGS. 12B and C, even in the case where the demultiplexer 400 according to the related art is used, it is unlikely to cause a shortage of voltage if the 1×1 Bar pattern or Dot Check pattern is employed.

The shortage of voltage occurs in the display of the Pixel Check pattern as described above because of the following reasons. FIG. 13 illustrates an example of a pitch conversion wiring part. FIG. 14 illustrates an equivalent circuit of the pitch conversion wiring part. In FIG. 14, a low-pass filter having a resistance R and a capacitance C is illustrated as an equivalent circuit.

FIG. 13 illustrates a pitch conversion pattern where the output terminal of the driver IC is connected to the input terminal of the demultiplexer. As illustrated in FIG. 13, the width where the driver IC output terminals are arrayed is narrower than the width where the active matrix is displayed. Thus, adjacent wirings are arrayed at shorter intervals near the output terminals of the driver IC. The interval between the wirings needs to be shorter because of the following reasons. The number of data lines is increased as the liquid crystal display panel has higher definition. Meanwhile, a space for the wirings is limited in order for the display apparatus to realize a narrowing frame. Thus, even in the case where the demultiplexer is used, wirings are jammed at the pitch conversion wiring part as illustrated in FIG. 13. The jammed state of wirings increases a fringe capacitance. The fringe capacitance corresponds to a capacitor C1 in FIG. 14.

It is difficult to lower the impedance of the output circuit of the driver IC due to the request for reduction in consumption power of the driver IC. It is thus difficult to increase the output current of the driver IC. Accordingly, a part of the output current of the driver IC is consumed by charging and discharging of the capacitor C illustrated in FIG. 14. Thus, no sufficient current can be supplied to the data lines, thereby causing a shortage of voltage in the drive signals. In particular, it is difficult to apply drive signals 100% at a time in the writing from black to white and from white to black. Accordingly, it is difficult to suppress a shortage of voltage by taking measures of reducing the resistance of the demultiplexer disposed between the driver IC and the data line or of optimizing the application capability.

Moreover, if the drive signals having different polarities are input in sequence, the potential held at the capacitance C is canceled and the voltage to be applied to the pixels is lowered.

As described above, as the display apparatus has higher definition and narrowing frame, it is difficult to completely apply signals with the same polarity from white to black and from black to white during only one selection period for the demultiplexer. Using the demultiplexer according to the related art as described above, a problem occurs in the case where the data of different colors are combined together for application. Even if a pattern of single color display such as all red, all blue or the like is employed, for example, the combination of the drive signals will be white to black and black to white. This raises a problem of lowering the contrast. Also in the case of a natural image, different colors have small correlation of data between adjacent pixels, and thus the drive signals may have the combinations of white to black and black to white. Thus, in the display of the Pixel Check pattern, a shortage of voltage may occur also in the display of a natural image unless the voltage shortage is suppressed. This causes problems of decreased contrast and increased flickers.

In order to solve the problems described above, a liquid crystal display apparatus according to Embodiment 1 is configured from the following points of view. First, such a property of image data is utilized that adjacent pieces of data with the same color has a large correlation and small variation in black and white. Embodiment 1 then employs a circuit configuration of the demultiplexer which rarely generates the combinations of applied drive signals from white to black and black to white, and a driving method which supplements the voltage shortage.

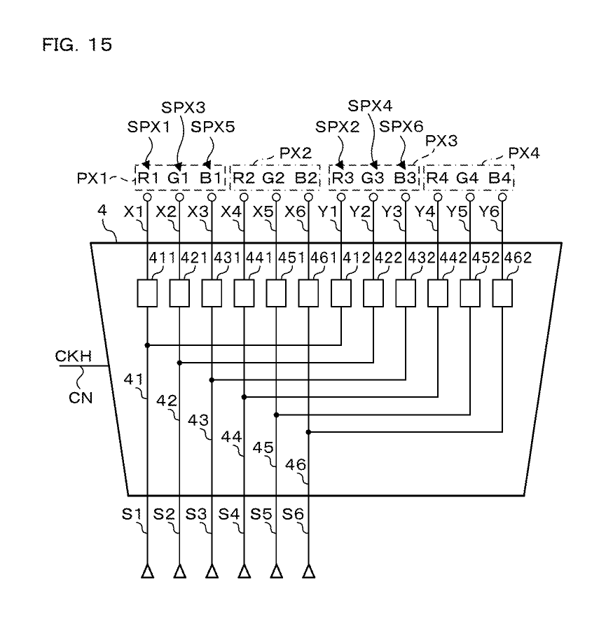

FIG. 15 illustrates the configuration of the demultiplexer 4 according to Embodiment 1. The demultiplexer 4 includes a first distribution unit 41, a second distribution unit 42, a third distribution unit 43, a fourth distribution unit 44, a fifth distribution unit 45 and a sixth distribution unit 46. Moreover, the demultiplexer 4 includes the control signal terminal CN to which the control signal CKH is input. The first distribution unit 41 to the sixth distribution unit 46 have similar configurations. As a representative, the first distribution unit 41 will be described below.

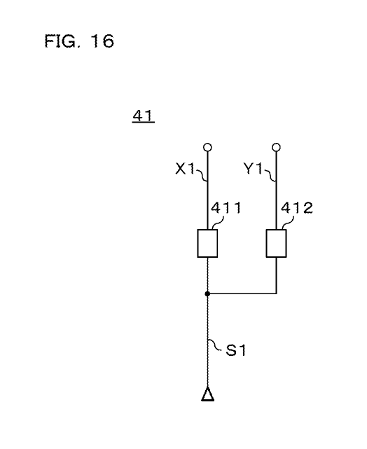

FIG. 16 illustrates a configuration of the first distribution unit 41. The first distribution unit 41 includes an input terminal S1, two switching elements 411 and 412, and two output terminals X1 and Y1. The switching element 411 is an element for switching the input terminal S1 and the output terminal X1 to be in either one of the electrically-connected state or electrically-disconnected state. The switching element 412 is an element for switching the input terminal S1 and the output terminal Y2 to be in either one of the electrically-connected state or electrically-disconnected state. Each of the switching elements 411 and 412 is a semiconductor element such as, for example, a transistor or a metal-oxide-semiconductor field-effect transistor (MOS FET). Each of the switching elements 411 and 412 takes either the connected state or the disconnected state depending on the control signal CKH input to the control terminal of the demultiplexer 4. The states of the switching elements 411 and 412 are so controlled as to be symmetric to each other. In the case where the switching element 411 is in the connected state, the switching element 412 is in the disconnected state. In the case where the switching element 411 is in the disconnected state, the switching element 412 is in the connected state. By the switching elements 411 and 412 operating as described above, the signal input through the input terminal S1 in the first distribution unit 41 is output from either one of the output terminal X1 or output terminal Y1. That is, the first distribution unit 41 distributes the signal input through the input terminal S1 to either one of the output terminal X1 or output terminal Y1. The second distribution unit 42 through the sixth distribution unit 46 operate similarly to the first distribution unit 41.

Accordingly, each of the first distribution unit 41 to the sixth distribution unit 46 takes either one of the two states depending on the control signal input to the demultiplexer 4. The input control signal CKH is common to all of the first distribution unit 41 to the sixth distribution unit 46. Thus, only two states may be taken even for the entire demultiplexer 4. As to which one of the two states is to be taken is controlled by the control signal CKH. Therefore, the control signal CKH is a digital signal of at least one bit.

A main pixel PXm (m is an integer from 1 to 4) illustrated in FIG. 15 includes a red subpixel Rm, a blue subpixel Bm and a green subpixel Gm. For example, the main pixel PX1 includes a red subpixel R1, a blue subpixel B1 and a green subpixel G1. The main pixels PX1 to PX4 are arrayed in one line as illustrated in FIG. 15. The arrangement direction of the main pixels PX1 to PX4 is the direction in which scanning lines are arrayed. The liquid crystal panel 101 as an example of a display part in the display apparatus 10 includes at least the first to fourth main pixels arrayed in one line. The first main pixel is, for example, a main pixel PX1. The second main pixel is, for example, a main pixel PX2. The third main pixel is, for example, a main pixel PX3. The fourth main pixel is, for example, a main pixel PX4. The second main pixel is adjacent to the first main pixel and the third main pixel. The fourth main pixel is adjacent to the third main pixel.

Each of the first main pixel to the fourth main pixel includes subpixels of the first to third colors arrayed in a line. The first color is red, for example. The second color is green, for example. The third color is blue, for example.

The drive signals output by the driver IC 14 are input to the input terminals S1 to S6 of the demultiplexer 4. Drive signals for driving subpixels output from the driver IC 14 are input to the respective output terminals X1 to X6 and Y1 to Y6 of the demultiplexer 4.

The demultiplexer 4 distributes drive signals as follows. Since the first distribution unit 41 to the sixth distribution unit 46 included in the demultiplexer 4 operates similarly as described above, the distributing operation of drive signals by the first distribution unit 41 will be described as a representative. The first distribution unit 41 distributes the drive signal input through the input terminal S1 to the subpixel SPX1 or the subpixel SPX2. As to which one of the subpixels SPX1 and SPX2 is to receive the drive signal distributed by the first distribution unit 41 is controlled by a control signal.

The demultiplexer 4 divides the subpixels included in two main pixels PX1 and PX3 into three subpixel groups. In FIG. 15, the k-th (k is an integer from 1 to 3) subpixel group includes the subpixel SPX2k-1 and the subpixel SPX2k of the k-th color. Here, the first color is red, the second color is green and the third color is blue. That is, the first to the N-th subpixel groups include subpixels of the first to N-th colors, respectively. The k-th subpixel group is corresponding with the k-th distribution unit (40+k). The k-th distribution unit simultaneously distributes the input drive signals. Moreover, subpixels included in two main pixels PX2 and PX4 are also grouped into three subpixel groups, as in the main pixels PX1 and PX3. Each subpixel group is corresponding with one distribution unit. That is, the distribution units respectively corresponding with the first to N-th subpixel groups simultaneously distribute the input drive signals.

In the check pattern described above, in order to suppress decrease in image quality, the demultiplexer 4 includes a distribution unit distributing, to any one of the subpixels included in a subpixel group, a drive signal for driving this one subpixel. The distribution unit corresponds to the first distribution unit 41 to the sixth distribution unit 46 in the example of FIG. 15.

For example, the first distribution unit 41 distributes, to any one of the subpixels (SPX1 and SPX2) included in a subpixel group, a drive signal for driving this one subpixel, as illustrated in FIGS. 15 and 16.

The subpixel group includes a plurality of subpixels included in a second plurality of main pixels among the first plurality of main pixels, one or more main pixels being interposed between the second plurality of main pixels, the plurality of subpixels being subpixels having a same color to which drive signals with a same polarity are input. In the example of the first distribution unit 41, the subpixel group includes a plurality of subpixels included in a second plurality of main pixels (PX1 and PX3) among the first plurality of main pixels, one or more main pixels PX2 being interposed between the second plurality of main pixels, the plurality of subpixels (SPX1 and SPX2) being subpixels having a same color to which drive signals of a same polarity are input. That is, the subpixel group includes the first and second subpixels (SPX1 and SPX2) included in two main pixels (PX1 and PX3) with one main pixel PX2 arrayed in between. The first and second subpixels are the subpixels having a same color to which the drive signals of the same polarity are input.

This configuration allows the driver IC 14, in the execution of a check pattern, to sequentially input the first drive signal for the first subpixel and the second drive signal for the second subpixel to the distribution unit corresponding with the first and second subpixels. The first drive signal and the second drive signal are drive signals having the same polarity and corresponding to the same luminance (black or white, for example). The display apparatus according to the present embodiment can, therefore, suppress decrease in image quality due to a shortage of voltage as described in FIGS. 10 and 11. It is noted that specific examples of the demultiplexer according to the present embodiment will be described later in Examples 1 and 2 below.

FIG. 15 illustrates one demultiplexer 4 and four main pixels PX1 to PX4 corresponding thereto. In the liquid crystal display apparatus 10, multiple sets of the demultiplexer 4 and main pixels PX1 to PX4 are arrayed in a direction of the scanning line, a so-called X direction. The number of sets of the demultiplexer 4 and the main pixels PX1 to PX4 is determined by the number of pixels in the X direction. Multiple sets of the main pixels PX1 to PX4 arrayed in the X direction are provided in the scanning direction, a so-called Y direction. The same demultiplexer 4 is corresponding with the main pixels PX1 to PX4 arrayed in the Y direction.

Accordingly, the driver IC 14 divides one scanning period into multiple periods. The driver IC 14 supplies a drive signal to a different subpixel for each period. The demultiplexer 4 includes a distribution unit respectively corresponding with each of the subpixel groups in one-to-one correspondence. The distribution units sequentially distributes drive signals which drive subpixels included in a subpixel group corresponding with the one of the distribution units to the subpixels. In the configuration illustrated in FIG. 15, the distribution unit corresponding with the subpixel group distributes the sequentially-input drive signals to the first subpixel and the second subpixel in sequence. Furthermore, as the demultiplexer 4 includes multiple distribution units 41 to 46, the drive signals input by the driver IC 14 are simultaneously distributed to a plurality of subpixels.

### Example 1

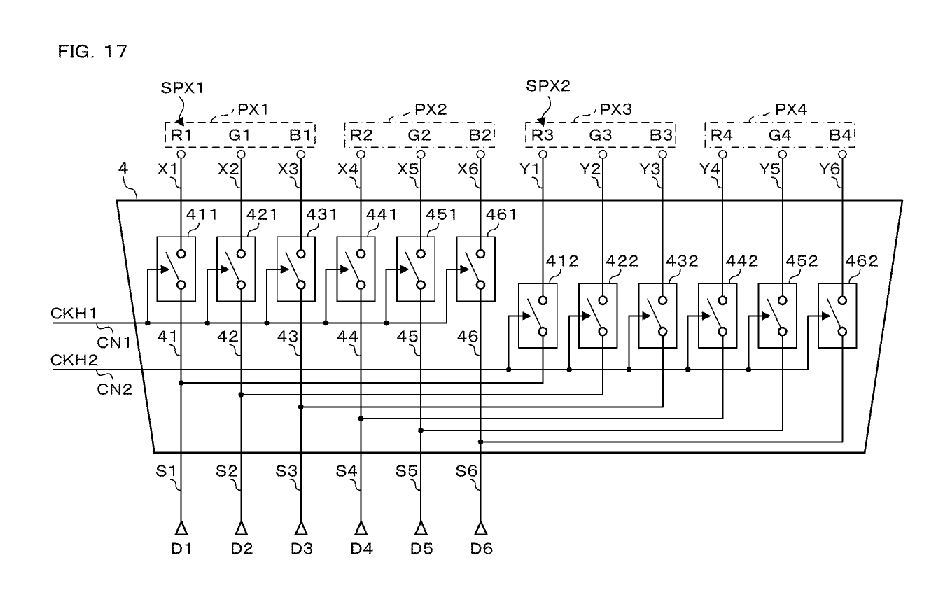

An example of the demultiplexer 4 included in the liquid crystal display apparatus 10 according to Embodiment 1 will now be described. FIG. 17 illustrates a configuration of the demultiplexer 4. In the demultiplexer 4 according to the present example, the control signal CKH is configured with two bits. A panel controller 143 generates the control signal CKH. The generated drive signal CKH is input to the demultiplexer 4. The control signal CKH includes the first control signal CKH1 (hereinafter simply referred to as “control signal CKH1”) and the second control signal CKH2 (hereinafter simply referred to as “control signal CKH2”). The demultiplexer 4 includes control signal terminals CN1 and CN2. The control signal CKH1 is input to the control signal terminal CN1. The control signal CKH2 is input to the control signal terminal CN2. For the switching elements illustrated in FIG. 17, mechanical switches are illustrated for convenience in order to describe the states that can be taken by the respective switches and the relationship between the control signal CKH1 and CKH2. The switching element 411 included in the first distribution unit 41 is controlled based on the control signal CKH1. FIG. 17 illustrates that the switching element 411 takes the disconnected state if the control signal CKH1 is not active. If the control signal CKH1 is active, the switching element 411 takes the connected state. Likewise, the switching element 412 included in the first distribution unit 41 is controlled based on the control signal CKH2. If the control signal CKH2 is not active, the switching element 412 takes the disconnected state. If the control signal CKH2 is active, the switching element 412 takes the connected state. It is noted that the control signals CKH1 and CKH2 correspond to positive logic signals (active high). That is, the control signals CKH1 and CKH2 are active at high (H). The control signals CKH1 and CKH2 are not active at low (L).

The first distribution unit 41 distributes the drive signal D1 input to the input terminal S1 as follows. If the control signal CKH1 is active whereas the control signal CKH2 is not active, the drive signal D1 is output from the output terminal X1. That is, the drive signal is applied to the subpixel SPX1. If the control signal CKH1 is not active whereas the control signal CKH2 is active, the drive signal D1 is output from the output terminal Y1. That is, the drive signal D1 is applied to the subpixel SPX2. The second distribution unit 42 through the sixth distribution unit 46 perform similar distributing operation.

The driver IC 14 outputs control signals and drive signals to the demultiplexer 4 on the premise of the configuration of the demultiplexer 4 shown in FIG. 17 and of the connection between the demultiplexer 4 and the main pixels as well as subpixels. The panel controller 143 sequentially outputs signals that make the control signals CKH1 and CKH2 active. The distribution units 41 to 46 in the demultiplexer 4 distributes drive signals to one of the subpixels included in a subpixel group, such as the subpixel SPX1, in response to the active signal of the control signal CKH1. The distribution units 41 to 46 in the demultiplexer 4 distribute drive signals to the other one of the subpixels included in the subpixel group, such as the subpixel SPX2, in response to the active signal of the control signal CKH2.

The subpixel group includes the first subpixel and the second subpixel. The first subpixel is, for example, a subpixel SPX1. The second subpixel is, for example, a subpixel SPX2. The drive signals are distributed to the first and second subpixels by the demultiplexer 4 in response to the first control signal and the second control signal. The first control signal is, for example, the control signal CKH1. The second control signal is, for example, the control signal CKH2. That is, the distribution units 41 to 46 distribute the drive signals for the first subpixel to the first subpixel in response to the first control signal. Moreover, the distribution units 41 to 46 distribute the drive signals for the second subpixel to the second subpixel in response to the second control signal. The first control signal (control signal CKH1) and the second control signal (control signal CKH2) that control the demultiplexer 4 are generated by the panel controller 143 which is an example of a control circuit. The panel controller 143 sequentially outputs the generated first and second control signals to the demultiplexer 4.

The description above will be specified below in more detail with reference to FIG. 17. The demultiplexer 4 distributes drive signals to subpixels included in the first to fourth main pixels. The first main pixel is, for example, a main pixel PX1. The second main pixel is, for example, a main pixel PX2. The third main pixel is, for example, a main pixel PX3. The fourth main pixel is, for example, a main pixel PX4.

The demultiplexer 4 includes a first distribution unit corresponding with the first subpixel group including the subpixels of the first color (red) included in the first main pixel and the third main pixel. The demultiplexer 4 includes a second distribution unit corresponding with the second subpixel group including the subpixels of the second color (green) included in the first main pixel and the third main pixel. The demultiplexer 4 includes a third distribution unit corresponding with the third subpixel group including the subpixels of the third color (blue) included in the first main pixel and the third main pixel. The demultiplexer 4 includes a fourth distribution unit corresponding with the fourth subpixel group including the subpixels of the first color (red) included in the second main pixel and the fourth main pixel. The demultiplexer 4 includes a fifth distribution unit corresponding with the fifth subpixel group including the subpixels of the second color (green) included in the second main pixel and the fourth main pixel. The demultiplexer 4 includes a sixth distribution unit corresponding with the sixth subpixel group including the subpixels of the third color (blue) included in the second main pixel and the fourth main pixel.

The description above is generalized in the following sentences. The demultiplexer 4 includes the i-th distribution unit corresponding with the i-th subpixel group in one-to-one correspondence, the i-th subpixel group including the subpixels of the i-th color included in the first main pixel and the third main pixel, the “i” being an integer of 1, 2 or 3. The demultiplexer 4 includes the (i+3)-th distribution unit corresponding with the (i+3)-th subpixel group in one-to-one correspondence, the (i+3)-th subpixel group including the subpixels of the i-th color included in the second main pixel and the fourth main pixel.

Furthermore, the distributing operation based on the first control signal and the second control signal is as follows. The i-th distribution unit distributes drive signals to subpixels included in the first main pixel in response to the first control signal. Along therewith, the (i+3)-th distribution unit distributes drive signals to subpixels included in the second main pixel in response to the first control signal. The i-th distribution unit distributes drive signals to subpixels included in the third main pixel in response to the second control signal. Along therewith, the (i+3)-th distribution unit distributes drive signals to subpixels included in the fourth main pixel in response to the second control signal.

The operation of applying drive signals in Example 1 is as follows. The control signal CKH1 is input to the switching element 4n1 (n is an integer from 1 to 6). The control signal CKH2 is input to the switching element 4n2.

When the control signal CKH1 rises from low to high, the switching element 4n1 is switched to the connected state (ON) in response to the rising. In the state where the control signal CKH1 is high, the control signal CKH2 is low. When the control signal CKH2 is low, the switching element 4n2 is turned off.

Subsequently, the control signal CKH1 falls from high to low, while the control signal CKH2 rises from low to high. The switching element 4n1 is then turned off in response to the falling. Moreover, the switching element 4n2 is turned on in response to the rising of the control signal CKH2.

In Example 1, the drive signals are applied to subpixels as described below. At the first application, the control signal CKH1 rises from low to high. The control signal CKH2 is low. The switching element 4n1 is turned on. Thus, the input terminal Sn is electrically connected with the output terminal Xn. Accordingly, the drive signal D1 input to the input terminal S1 is applied to the subpixel R1 through the output terminal X1. The drive signal D2 input to the input terminal S2 is applied to the subpixel G1 through the output terminal X2. The drive signal D3 input to the input terminal S3 is applied to the subpixel B1 through the output terminal X3. The drive signal D4 input to the input terminal S4 is applied to the subpixel R2 through the output terminal X4. The drive signal D5 input to the input terminal S5 is applied to the subpixel G2 through the output terminal X5. The drive signal D6 input to the input terminal S6 is applied to the subpixel B2 through the output terminal X6, When the first application is finished, the control signal CKH1 falls from high to low. Thereafter, the control signal CKH2 rises from low to high for the second application. The switching element 4n2 is turned on. Thus, the input terminal Sn is electrically connected with the output terminal Yn. Accordingly, the drive signal D1 input to the input terminal S1 is applied to the subpixel R3 through the output terminal Y1. The drive signal D2 input to the input terminal S2 is applied to the subpixel G3 through the output terminal Y2. The drive signal D3 input to the input terminal S3 is applied to the subpixel B3 through the output terminal Y3. The drive signal D4 input to the input terminal S4 is applied to the subpixel R4 through the output terminal Y4. The drive signal D5 input to the input terminal S5 is applied to the subpixel G4 through the output terminal Y5. The drive signal D6 input to the input terminal S6 is applied to the subpixel B4 through the output terminal Y6.

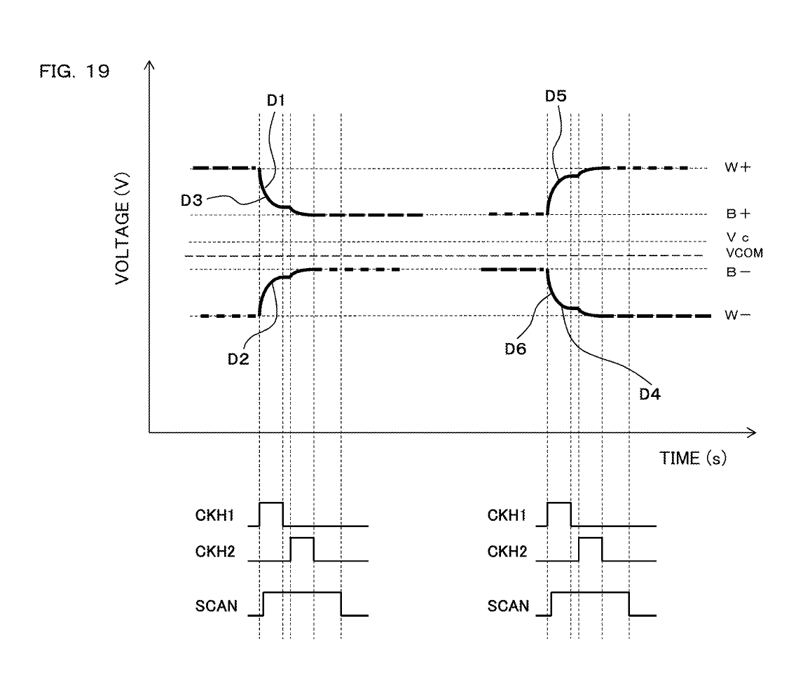

It is noted that the signal levels of the control signals CKH1 and CKH2 described earlier are mere examples, and are more specifically illustrated in the signal waveform view for the control signals CKH1 and CKH2 shown in FIG. 19.

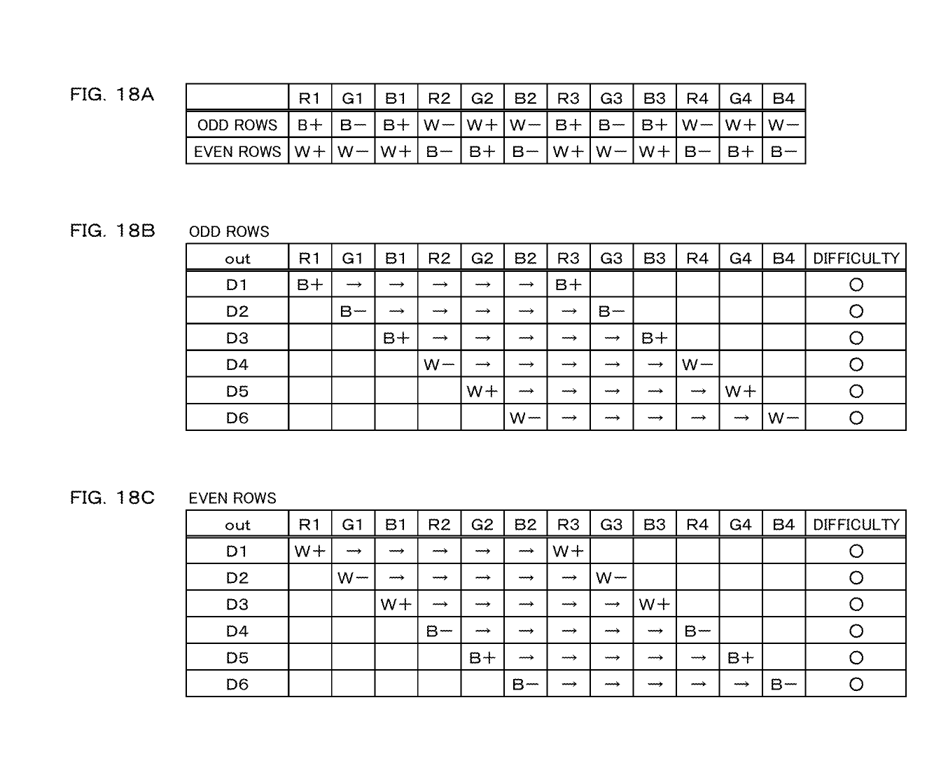

FIGS. 18A-18C illustrates control performed when the Pixel Check pattern is displayed. FIGS. 18A-18C illustrates details of the control for each subpixel in the case where the Pixel Check pattern is displayed. FIG. 18B illustrates the order of application to subpixels in the odd rows. FIG. 18C illustrates signal application to subpixels in the even rows. The manner of expression is similar to that in FIGS. 10A-10C. D1 to D6 are drive signals output from the driver IC. The drive signals D1 to D6 are respectively input to the input terminals S1 to S6 of the demultiplexer 4.

As illustrated in FIGS. 18A and 18B, both in the odd rows and even rows, the demultiplexer 4 applies drive signals having the same luminance (WB) and the same polarity (+−) at the first and second applications, which makes the second application easy in all the subpixels. As illustrated in FIGS. 18A and 18B, the subpixels R1, G1, B1, R2, G2 and B2 are the subjects for the first application. The subpixels R3, G3, B3, R4, G4 and B4 are the subjects for the second application.

FIG. 19 is a timing chart illustrating a drive waveform. FIG. 19 illustrates a drive waveform in the case of writing to the odd rows as shown in FIG. 18B. D1 to D6 in FIG. 19 correspond to D1 to D6 described in FIG. 18B. In the application of any drive signals, a shortage of voltage occurs at the first time, but sufficient application may be carried out at the second time. Comparing the two applications, the second application has less time for application to a subpixel than the first application. Thus, if a shortage of voltage occurs at the second time, it is more likely that decrease in image quality such as a flicker occurs. In the present embodiment, no shortage of voltage occurs at the second application, which makes it possible to suppress decrease in image quality.

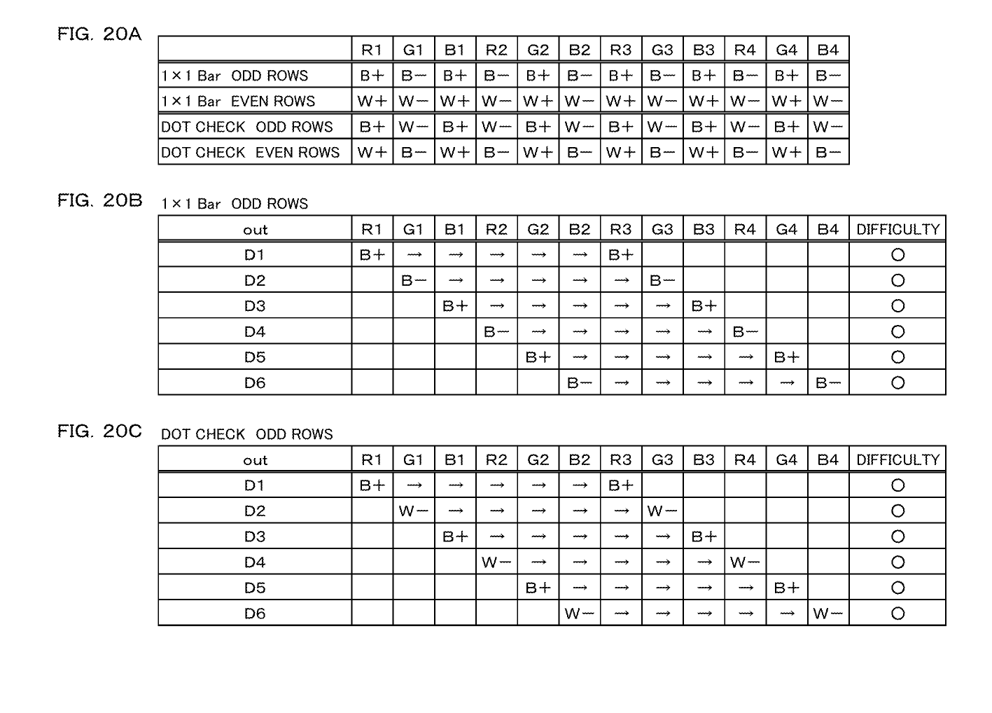

Next, the operation performed in the case where a pattern other than the Pixel Check pattern is displayed. FIGS. 20A-20C illustrates control performed when a 1×1 Bar pattern and a Dot Check pattern are displayed. The manner of expression in FIGS. 20A-20C is similar to that in FIGS. 12A-12C, and thus will not be described here. As illustrated in FIGS. 20B and 20C, the second application is easy in either one of the 1×1 Bar pattern and the Dot Check pattern. While FIGS. 20B and 20C do not indicate even rows, the second application to the even rows is also easy similarly to the odd rows.

As illustrated in FIGS. 18B, 18C, 20B and 20C, the drive signals D1 to D6 have the same polarity at the first and second applications. That is, if the first application has the positive polarity (+), the second application also has the positive polarity. Moreover, if the first application has the negative polarity (−), the second application also has the negative polarity. The source driver 145 outputs a drive signal of the first polarity or a drive signal of the second polarity, as a drive signal. The first polarity is, for example, the positive polarity. The second polarity is, for example, the negative polarity. As described above, the source driver 145 outputs drive signals of the same polarity to each distribution unit at the first and second applications. The first and second applications are carried out during the same scanning period. Thus, the source driver 145, which is an example of a driver circuit, outputs drive signals of the same polarity to the distribution unit in a period where scanning is performed on the subpixels included in multiple main pixels arrayed in one line.

Moreover, as illustrated in FIGS. 18B, 18C, 20B and 20C, the source driver 145 outputs drive signals of different polarities to the subpixels adjacent to each other. That is, the driver circuit outputs the drive signal of the first polarity for driving the first subpixel to the distribution unit corresponding with the subpixel group including the first subpixel. Furthermore, the driver circuit outputs the drive signal of the second polarity for driving the second subpixel to the distribution unit corresponding with the subpixel group including the second subpixel adjacent to the first subpixel.

As described above, according to the present example, subpixels are divided into groups from the perspective that the drive signals having the same color and the same polarity are applied thereto. Accordingly, even in the case where the Pixel Check pattern is displayed, no shortage of voltage occurs at the second application. This can suppress decrease in image quality.

### Example 2

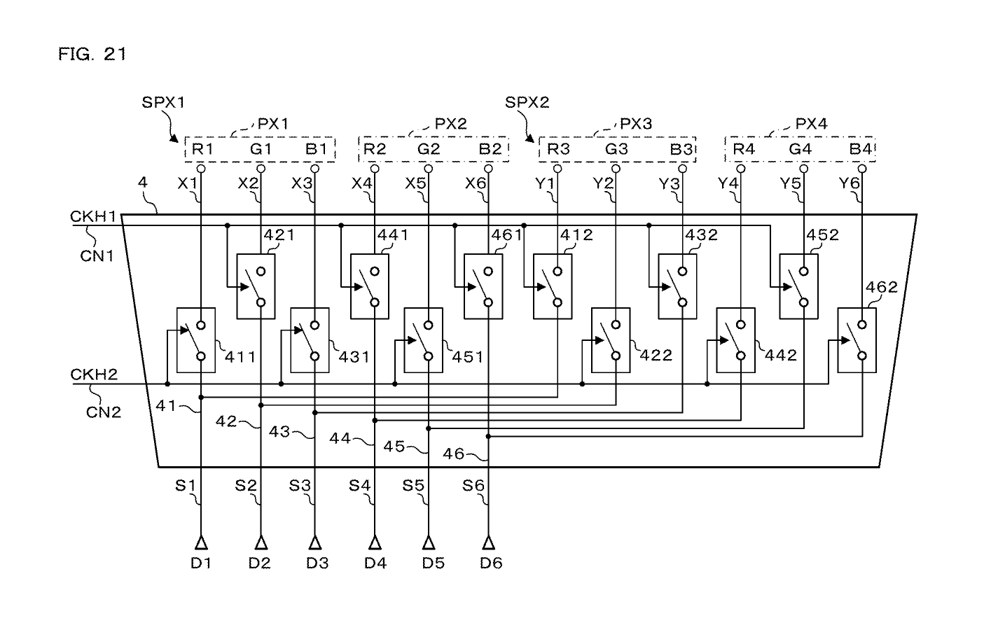

Another example of the demultiplexer 4 included in the liquid crystal display apparatus 10 according to Embodiment 1 will now be described. FIG. 21 illustrates a configuration of the demultiplexer 4. Example 2 is different from Example 1 in the switching element to which the control signals CKH1 and CKH2 are input.

The association between subpixels and distribution units in the demultiplexer 4 in Example 2 is similar to that in Example 1. Also, the control signals CKH1 and CKH2 are configured as in Example 1. Moreover, main pixels and subpixels are arrayed similarly to Example 1. The control signal CKH1 is input to the switching elements 421, 441, 461, 412, 432 and 452. The control signal CKH2 is input to the switching elements 411, 431, 451, 422, 442 and 462.

When the control signal CKH1 rises from low to high, the switching elements 421, 441, 461, 412, 432 and 452 are switched to the connected state (ON) in response to the rising. In the state where the control signal CKH1 is high, the control signal CKH2 is low. When the control signal CKH2 is low, the switching elements 411, 431, 451, 422, 442 and 462 are turned off.

Subsequently, the control signal CKH1 falls from high to low, while the control signal CKH2 rises from low to high. The switching elements 421, 441, 461, 412, 432 and 452 are then turned off in response to the falling of the control signal CKH1. The switching elements 411, 431, 451, 422, 442 and 462 are turned on in response to the rising of the control signal CKH2.

In Example 2, the operation of the demultiplexer 4 may also be expressed as follows. The first distribution unit distributes drive signals to subpixels included in the third main pixel in response to the first control signal. Along therewith, the second distribution unit distributes drive signals to subpixels included in the first main pixel in response to the first control signal. Along therewith, the third distribution unit distributes drive signals to subpixels included in the third main pixel in response to the first control signal. Along therewith, the fourth distribution unit distributes drive signals to subpixels included in the second main pixel in response to the first control signal. Along therewith, the fifth distribution unit distributes drive signals to subpixels included in the fourth main pixel in response to the first control signal. Along therewith, the sixth distribution unit distributes drive signals to subpixels included in the second main pixel in response to the first control signal.

Moreover, the first distribution unit distributes drive signals to subpixels included in the first main pixel in response to the second control signal. Along therewith, the second distribution unit distributes drive signals to subpixels included in the third main pixel in response to the second control signal. Along therewith, the third distribution unit distributes drive signals to subpixels included in the first main pixel in response to the second control signal. Along therewith, the fourth distribution unit distributes drive signals to subpixels included in the fourth main pixel in response to the second control signal. Along therewith, the fifth distribution unit distributes drive signals to subpixels included in the second main pixel in response to the second control signal. Along therewith, the sixth distribution unit distributes drive signals to subpixels included in the fourth main pixel in response to the second control signal.

Accordingly, the operation of the first to sixth distribution units are generalized as follows. The (2i−1)-th distribution unit distributes drive signals to subpixels included in the (i div 3+3)-th main pixel in response to the first control signal. Together therewith, the 2i-th distribution unit distributes drive signals to subpixels included in the (i div 2+1)-th main pixel in response to the first control signal. Moreover, the (2i−1)-th distribution unit distributes drive signals to subpixels included in the (i div 3+1)-th main pixel in response to the second control signal. Together therewith, the 2i-th distribution unit distributes drive signals to subpixels included in the (i div 2+3)-th main pixel in response to the second control signal. As described earlier, i is an integer of 1, 2 or 3. Furthermore, n div m represents an integer part of the quotient obtained by dividing n by m.

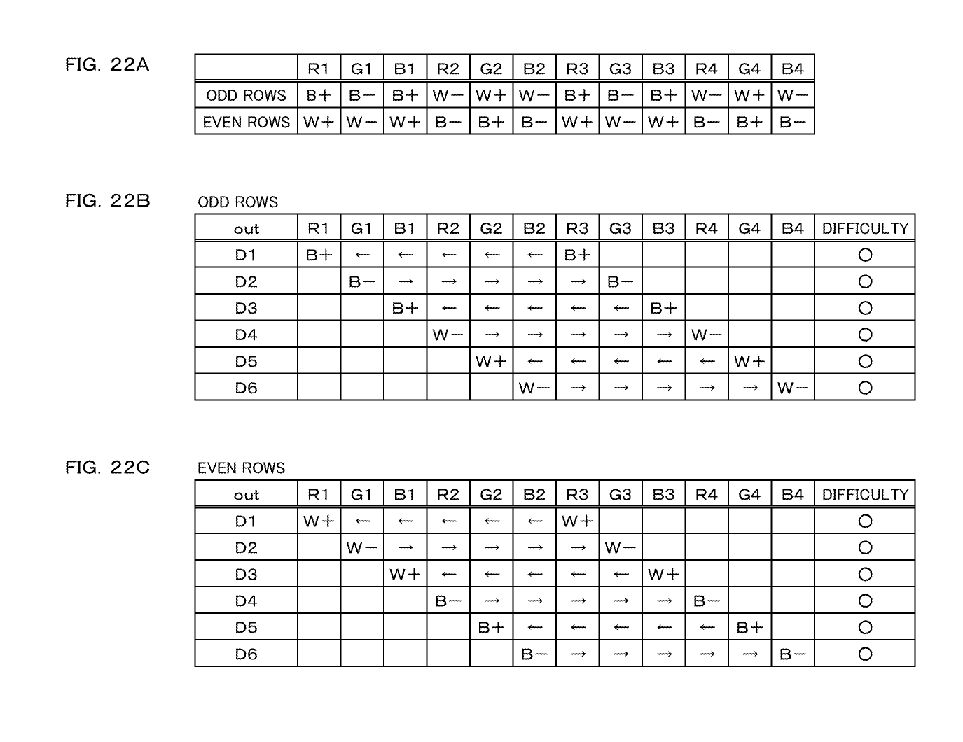

FIGS. 22A-22C illustrates control performed in the case where the Pixel Check pattern is displayed. FIG. 22A illustrates details of the control for each subpixel in the case where the Pixel Check pattern is displayed. FIG. 22B illustrates the order of writing to subpixels in the odd rows. FIG. 22C illustrates the order of application to subpixels in the even rows. The manner of expression is similar to that in FIGS. 10A-10C. D1 to D6 are drive signals output from the driver IC. The drive signals D1 to D6 are respectively input to the input terminals S1 to S6 of the demultiplexer 4.

As illustrated in FIGS. 22B and 22C, both in the odd rows and even rows, the demultiplexer 4 applies drive signals having the same luminance (WB) and the same polarity (+−) at the first and second applications, which makes the second writing easy in all the subpixels.

Moreover, as illustrated in FIGS. 22B and 22C, the subpixels R3, G1, B3, R2, G4 and B2 are the subjects for the first application. The subpixels R1, G3, B1, R4, G2 and B4 are the subjects for the second application. In the present example, in any one of the first and second applications, no drive signals are applied to adjacent subpixels. The wirings to the adjacent subpixels are so arrayed as to be adjacent to each other. In the case where the drive signals flow in the adjacent wirings, therefore, capacitive coupling is generated between the wirings. In the present embodiment, however, a volatage application which the drive signals flow in the adjacent wirings simultaneously is not exist, which makes it possible to reduce the capacitive coupling.

In the present example, the subpixels are divided into groups from the perspective that the drive signals having the same color and the same polarity are applied thereto. Accordingly, even in the case where the Pixel Check pattern is displayed, no shortage of voltage occurs at the second application. This can thus suppress decrease in image quality. Furthermore, no simultaneous application is carried out to the adjacent subpixels. This can reduce the capacitive coupling generated between the wirings to the adjacent subpixels.

### Embodiment 2

The present embodiment relates to a form where the shortage of voltage at the first application is improved. According to the present embodiment, the shortage of voltage at the first application is improved by the following way.

In Embodiment 1, the grouping of the subpixels and the distribution method of drive signals by the demultiplexer 4 improve the second application. It is thus configured that no shortage of voltage occurs in the second application even with a shorter application time. Here, the second application time is shortened and therefore the first application time is extended by the amount corresponding to the shortened time, to improve the shortage of voltage in the first application.

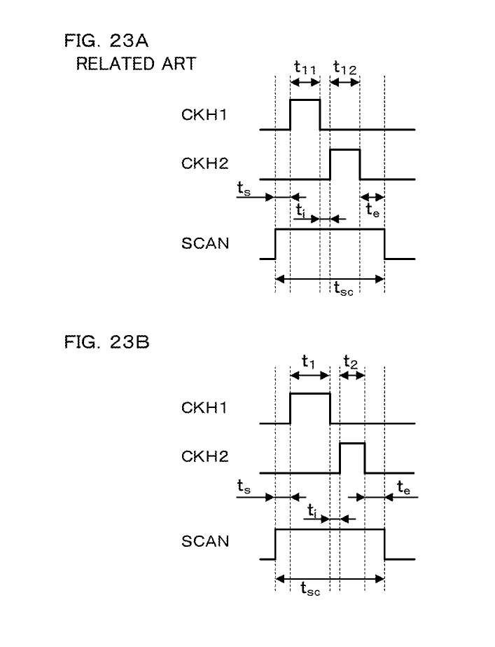

FIGS. 23A-23B is a time chart illustrating drive timing of the demultiplexer 4. FIG. 23A illustrates the drive timing of a demultiplexer according to the related art. FIG. 23B illustrates the drive timing of the demultiplexer 4 according to the present embodiment. In FIGS. 23A-23B, CKH1 and CKH2 represent control signals of the demultiplexer 4. SCAN represents a scanning signal.

The period where SCAN is high corresponds to one scanning period. In the scanning period, the plurality of subpixels arrayed in one line are simultaneously scanned. The control circuit outputs the first control signal and thereafter outputs the second control signal in the scanning period. As described earlier, the first control signal is, for example, the control signal CKH1. The second control signal is, for example, the control signal CKH2.

In FIG. 23A, the scanning period is indicated as t_{sc}. The first selection period is indicated as t₁₁. The second selection period is indicated as t₁₂. The period from the start of the scanning period to the start of the first selection period is indicated as tₛ. The switching period provided between the first selection period and the second selection period is indicated as tᵢ. The period from the end of the second selection period t₁₂ to the end of the scanning period is indicated as tₑ. The selection period t₁₁ corresponds to the first application time. The selection period t₁₂ corresponds to the second application time. As illustrated in FIG. 23A, in the demultiplexer in the related art, the equations (11) and (12) below are satisfied.

t_{sc}=tₛ+t₁₁+tᵢ+t₁₂+tₑ (11)

t₁₁=t₁₂ (12)

In the demultiplexer according to the related art, the first application time has the same length as the second application time.

In FIG. 23B, the scanning period t_{sc}, period tₛ, switching period tᵢ and period tₑ are similar to those in FIG. 23A. In FIG. 23B, the first selection period is indicated as t₁. The second selection period is indicated as t₂. The selection period t₁ corresponds to the first application time. The selection period t₂ corresponds to the second application time. As illustrated in FIG. 23B, in the demultiplexer 4 according to the present embodiment, the equations (1) and (2) below are satisfied.

t_{sc}=tₛ+t₁+tᵢ+t₂+tₑ (1)

t₁>t₂ (2)

As indicated in the equation (2), the second selection period t₂ is shortened. The first selection period t₁ is extended by the amount corresponding to the shortened time. In other words, the second application time is shortened whereas the first application time is extended.

As described above, the driver IC 14 outputs the first control signal CKH1 to the control signal terminal CN1 of the demultiplexer 4 during the first period. Moreover, the driver IC 14 outputs the second control signal CKH2 to the control signal terminal CN2 of the demultiplexer 4 during the second period. The first period is, for example, the first selection period t₁₁. The second period is, for example, the second selection period t₁₂. The first period is made longer than the second period. That is, the first period during which the first control signal CKH1 is output to the demultiplexer 4 is longer than the second period during which the second control signal CKH2 is output to the demultiplexer 4.

According to the present embodiment, the first application time is made longer than the second application time, thereby improving the shortage of voltage at the first application.

### Embodiment 3

The present embodiment relates to a form where the shortage of voltage at the first application is improved. According to the present embodiment, the shortage of voltage at the first application is improved by the following way.

The first application time is further extended compared to Embodiment 2. For this purpose, the control signal CKH1 is made active before the scanning signal is made active. This allows the period during which the control signal CKH1 is active, i.e. the first selection period, to be longer.

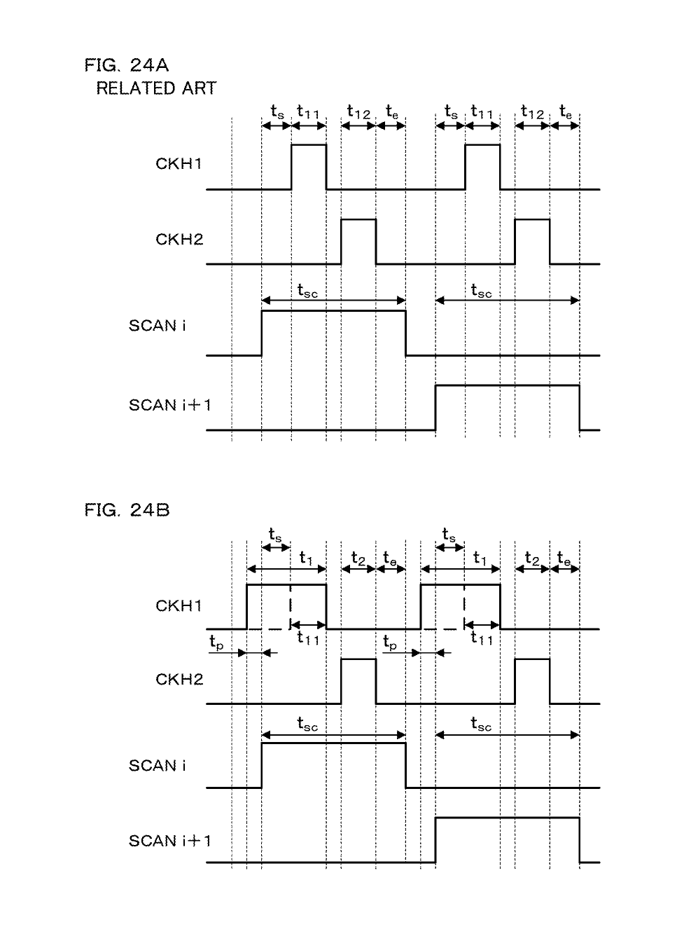

FIGS. 24A-24B is a time chart illustrating drive timing of a demultiplexer. FIG. 24A illustrates the drive timing of a demultiplexer according to the related art. FIG. 24B illustrates the drive timing of the demultiplexer 4 according to the present embodiment. In FIGS. 24A-24B, CKH1 and CKH2 represent control signals of the demultiplexer 4. SCAN i indicates the scanning signal on the i-th scanning line. SCAN i+1 indicates the scanning signal on the (i+1)-th scanning line.

In FIG. 24A, the scanning period is indicated as t_{sc}. The first selection period is indicated as t₁₁. The second selection period is indicated as t₁₂. The period from the start of the scanning period to the first selection period is indicated as tₛ.

In FIG. 24B, the scanning period is indicated as t_{sc}. The first selection period is indicated as t₁. The second selection period is indicated as t₂. The period from the start of the first selection period to the start of the scanning period is indicated as tₚ.

As illustrated in FIG. 24B, the start of the first selection period is moved to a point earlier than the start of the scanning period. The output of the first control signal is started before the scanning period. This allows the first selection period to be longer than that for the drive timing according to the related art shown in FIG. 24A. First, the timing of making the scanning signal active and the timing of making the control signal CKH1 active are inverted from each other, so as to eliminate the period tₛ in FIG. 24A (time difference between the timing at which the scanning signal SCAN i rises and the timing at which the first control signal CKH1 rises). Furthermore, the period tₚ generated by starting earlier is present. Therefore, the first selection period t₁ may be represented by the equation (3) below.

t₁=t₁₁+tₛ+tₚ (3)

That is, the first selection period t₁ may be extended to be longer than the selection period t₁₁ in the related art by (tₛ+tₚ). The first application time may be extended to be longer than the application time in the related art by (tₛ+tₚ).

According to the present embodiment, the first application time is made longer, thereby improving the shortage of voltage at the first application. Combination of Embodiment 2 and the present embodiment may further extend the first application time.

### Embodiment 4

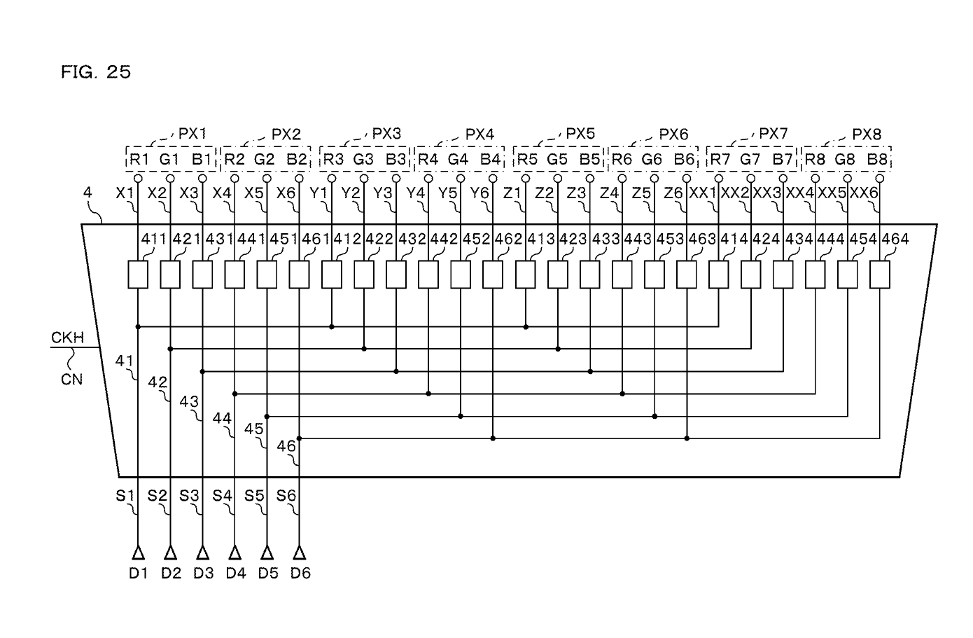

Embodiments described above illustrate the demultiplexer with the 6-to 12 structure, i.e. 1-to-2 structure. The present embodiment relates to the demultiplexer with a 6-to-24 structure, i.e. 1-to-4 structure. FIG. 25 illustrates a configuration of another demultiplexer 4. The demultiplexer 4 includes a first distribution unit 41, a second distribution unit 42, a third distribution unit 43, a fourth distribution unit 44, a fifth distribution unit 45 and a sixth distribution unit 46. Moreover, the demultiplexer 4 includes the control signal terminal CN to which the control signal CKH is input.

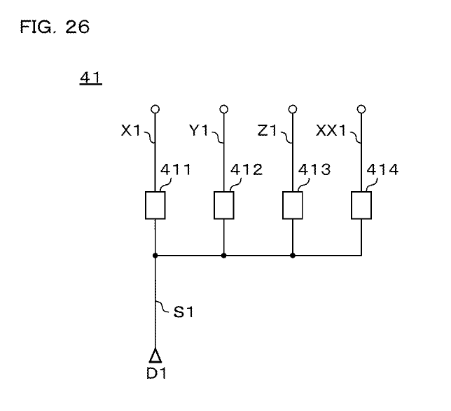

FIG. 26 illustrates a configuration of the first distribution unit. The first distribution unit 41 includes an input terminal S1, and switching elements 411, 412, 413 and 414. The first distribution unit 41 distributes the drive signal D1 input to the input terminal S1 in accordance with the control signal CKH. One terminal of the switching element 411 is connected to the input terminal S1. The other terminal of the switching element 411 is connected to the output terminal X1. One terminal of the switching element 412 is connected to the input terminal S1. The other terminal of the switching element 412 is connected to the output terminal Y1. One terminal of the switching element 413 is connected to the input terminal S1. The other terminal of the switching element 413 is connected to the output terminal Z1. One terminal of the switching element 414 is connected to the input terminal S1. The other terminal of the switching element 414 is connected to the output terminal XX1.

The switching elements 411 to 414 are switched between the connected state and the disconnected state based on the control signal CKH. One of the switching elements 411 to 414 is made in the connected state while three of them are made in the disconnected state in accordance with the control signal CKH, so that the drive signal D1 input to the input terminal S1 may be distributed to any one of the output terminals X1, Y1, Z1 and XX1.

When the switching element 411 is in the connected state whereas the switching elements 412 to 414 are in the disconnected state, the drive signal D1 input to the input terminal S1 is output from the output terminal X1. When the switching element 412 is in the connected state whereas the switching elements 411, 413 and 414 are in the disconnected state, the drive signal D1 input to the input terminal S1 is output from the output terminal Y1. When the switching element 413 is in the connected state whereas the switching elements 411, 412 and 414 are in the disconnected state, the drive signal D1 input to the input terminal S1 is output from the output terminal Z1. When the switching element 414 is in the connected state whereas the switching elements 411 to 413 are in the disconnected state, the drive signal D1 input to the input terminal S1 is output from the output terminal XX1. The second distribution unit 42 to the sixth distribution unit 46 operate similarly to the first distribution unit 41.

The demultiplexer 4 distributes six drive signals simultaneously by the first distribution unit 41 to the sixth distribution unit 46. As each distribution unit has four output terminals, four types of control signals are required for the control signal CKH. That is, the first control signal to the fourth control signal are input to the control signal terminal CN of the demultiplexer 4.

Each output terminal of the demultiplexer 4 corresponds to one subpixel. The drive signal output from each output terminal of the demultiplexer 4 is input to a corresponding subpixel. The demultiplexer 4 in FIG. 25 has twenty-four output terminals, and thus corresponds to twenty-four subpixels, or eight main pixels. Since six input terminals are provided, drive signals may be distributed to six subpixels at the same time. PX1 to PX8 shown in FIG. 25 represent main pixels. The main pixel PX1 includes subpixels R1, G1 and B1. The subpixel R1 represents a subpixel of red. The subpixel G1 represents a subpixel of green. The subpixel B1 represents a subpixel of blue. The other main pixels PX2 to PX8 are similar to the main pixel PX1.

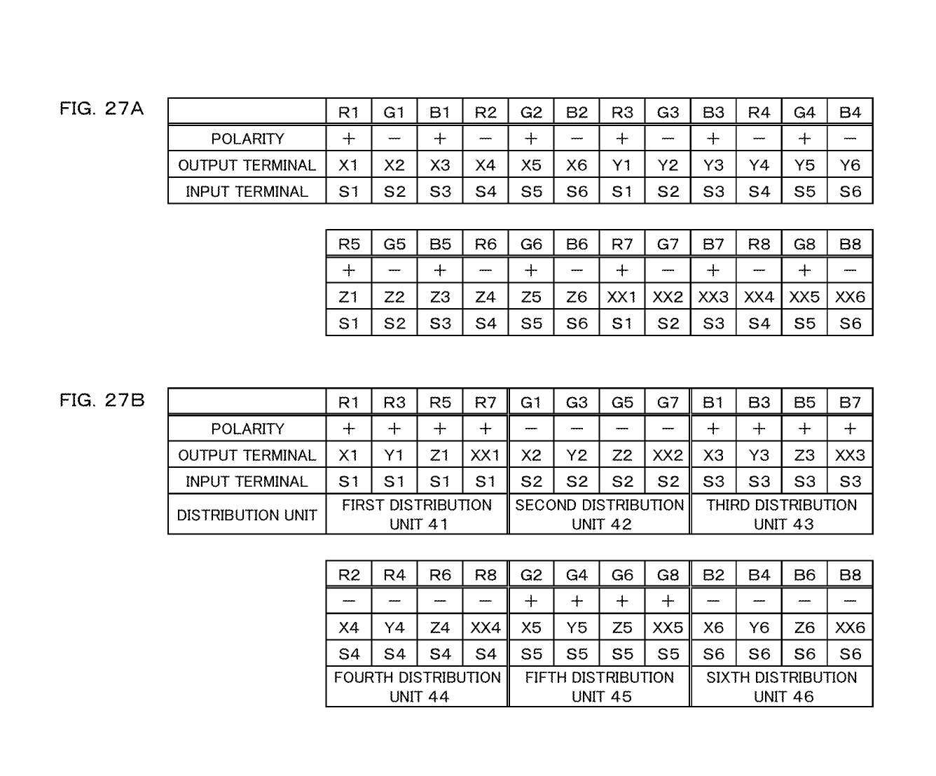

FIGS. 27A-27B illustrates the association between the demultiplexer 4 and subpixels. FIG. 27A illustrates the subpixels in the same order as that shown in FIG. 25. The “polarity” column indicates the polarity of a drive signal input to each of the other subpixels when a drive signal of the negative polarity is input to the subpixel R1 of the main pixel PX1. The positive polarity is indicated as “+.” The negative polarity is indicated as “−.” The “output terminal” column indicates the output terminal of the demultiplexer 4 corresponding with each subpixel. The “input terminal” column indicates the input terminal corresponding to the output terminal.

FIG. 27B shows another arrangement of subpixels different from FIG. 27A. In FIG. 27B, subpixels are sorted by the distribution unit, while corresponding distribution units are also indicated. The subpixel group corresponding with the first distribution unit 41 includes four subpixels R1, R3, R5 and R7. The subpixel R1 is included in the main pixel PX1. The subpixel R3 is included in the main pixel PX3. The subpixel R5 is included in the main pixel PX5. The subpixel R7 is included in the main pixel PX7. Each of the four subpixels is included in every other main pixel according to the order of arrangement. The four subpixels are all red, the same color. Moreover, when the drive signal of the negative polarity is input to the subpixel R1, drive signals of the negative polarity are also input to the other subpixels R3, R5 and R7. That is, the drive signals of the same polarity are input to the four subpixels. The first distribution unit 41 sequentially distributes the drive signals D1 that are sequentially input through the input terminal S1 to the four subpixels.

For the subpixel groups corresponding with the first distribution unit 41 to the sixth distribution unit 46, similarity is present as described below. The subpixel groups include the first to fourth subpixels respectively included in first to fourth main pixels, the first to fourth main pixels being arrayed every other, the first to fourth subpixels being the subpixels having the same color to which the drive signals of the same polarity are input. The distribution unit corresponding with the subpixel group distributes the sequentially-input drive signals to the first subpixel to the fourth subpixel in sequence.

Moreover, the distributing operation performed by the first distribution unit 41 to sixth distribution unit 46 may be expressed in general as follows. The panel controller 143 which is an example of a control circuit configured to generates the j-th control signal (j is an integer of 1, 2, 3 or 4) to control the demultiplexer 4, and sequentially to output the generated first to fourth control signals to the demultiplexer 4. The first distribution unit 41 to the sixth distribution unit distribute the drive signals for the j-th subpixel to the j-th subpixel in response to the j-th control signal.

In the present embodiment, the subpixels are divided into groups from the perspective that the drive signals having the same color and the same polarity are applied thereto as in Embodiment 1. Accordingly, even in the case where the Pixel Check pattern is displayed, no shortage of voltage occurs at the second application. This can thus suppress the lowering in luminance or the occurrence of flickers.

The technical features (components) described in each embodiment may be combined with one another, and such combinations may form new technical features.

It should be understood that the embodiments disclosed herein are illustrative and non-restrictive in every respect. Since the scope of the present invention is defined by the appended claims rather than by the description preceding them, all changes that fall within metes and bounds of the claims, or equivalence of such metes and bounds thereof are therefore intended to be embraced by the claims.

What is claimed is:

1. A display apparatus, comprising:
a display unit in which a first plurality of main pixels including subpixels of a first color to an Nth color are arrayed in a line, the “N” being an integer larger than 1; and
a demultiplexer including a distribution unit configured to distribute a drive signal which drives any one of a plurality of subpixels included in a subpixel group to the one of the plurality of subpixels,
wherein the subpixel group includes a plurality of subpixels included in a second plurality of main pixels among the first plurality of main pixels, one or more main pixels being interposed between the second plurality of main pixels, the plurality of subpixels being subpixels having a same color to which drive signals of a same polarity are input.

2. The display apparatus according to claim 1, wherein
the demultiplexer includes a plurality of distribution units respectively corresponding with subpixel groups in one-to-one correspondence, and
at least one of the distribution units sequentially distributes drive signals which drive subpixels included in a subpixel group corresponding with the one of the distribution units to the subpixels.

3. The display apparatus according to claim 2, wherein
each of first to N-th subpixel groups includes subpixels of first to N-th colors, and
a first to N-th distribution units respectively corresponding with the first to N-th subpixel groups simultaneously distribute input drive signals.

4. The display apparatus according to claim 2, wherein
the subpixel group includes first and second subpixels included in two main pixels with one main pixel interposed between the two main pixels, the first and second subpixels being subpixels having a same color to which drive signals of a same polarity are input, and
a distribution unit corresponding with the subpixel group sequentially distributes the drive signals that are sequentially input, to the first subpixel and the second subpixel.

5. The display apparatus according to claim 4, further comprising a control circuit configured to generate a first control signal and a second control signal to control the demultiplexer, and sequentially to output the generated first and second control signals to the demultiplexer,
wherein the distribution unit distributes a drive signal which drives the first subpixel to the first subpixel in response to the first control signal, and distributes a drive signal which drives the second subpixel to the second subpixel in response to the second control signal.

6. The display apparatus according to claim 5, wherein
the N is 3,
the display unit includes at least first to fourth main pixels arrayed in a line, the second main pixel is adjacent to the first main pixel and the third main pixel, and the fourth main pixel is adjacent to the third main pixel,
each of the first main pixel to the fourth main pixel includes subpixels of a first color to a third color arrayed in a line, and the demultiplexer includes:
an i-th distribution unit corresponding with an i-th subpixel group in one-to-one correspondence, the i-th subpixel group including subpixels of an i-th color included in the first main pixel and the third main pixel, the “i” being an integer of 1, 2 or 3; and
an i+3 distribution unit corresponding with an i+3 subpixel group in one-to-one correspondence, the i+3 subpixel group including subpixels of an i-th color included in the second main pixel and the fourth main pixel.

7. The display apparatus according to claim 6, wherein
the i-th distribution unit distributes a drive signal to a subpixel included in the first main pixel in response to the first control signal, while the (i+3)-th distribution unit distributes a drive signal to a subpixel included in the second main pixel in response to the first control signal, and the i-th distribution unit distributes a drive signal to a subpixel included in the third main pixel in response to the second control signal, while the (i+3)-th distribution unit distributes a drive signal to a subpixel included in the fourth main pixel in response to the second control signal.

8. The display apparatus according to claim 6, wherein
the (2i−1)-th distribution unit distributes a drive signal to a subpixel included in the (i div 3+3)-th main pixel in response to the first control signal, while the 2i-th distribution unit distributes a drive signal to a subpixel included in the (i div 2+1)-th main pixel in response to the first control signal,
the (2i−1)-th distribution unit distributes a drive signal to a subpixel included in the (i div 3+1)-th main pixel in response to the second control signal, while the 2i-th distribution unit distributes a drive signal to a subpixel included in the (i div 2+3)-th main pixel in response to the second control signal, and
n div m indicates an integer unit of a quotient obtained by dividing n by m.

9. The display apparatus according to claim 6, wherein
in a scanning period during which the plurality of subpixels arrayed in a line are simultaneously scanned, the control circuit outputs the second control signal after the first control signal is output, and
the first period during which the first control signal is output to the demultiplexer is longer than the second period during which the second control signal is output to the demultiplexer.

10. The display apparatus according to claim 6, wherein
the control circuit starts outputting the first control signal before a scanning period during which the plurality of subpixels arrayed in a line simultaneous scanned.

11. The display apparatus according to claim 2, wherein
the distribution unit further includes a driver circuit configured to output a drive signal which includes a first polarity and which drives a subpixel or a drive signal which includes a second polarity and which drives a subpixel, and
the driver circuit outputs drive signals of a same polarity to the distribution unit in a period during which the plurality of subpixels arrayed in a line scanned.

12. The display apparatus according to claim 11, wherein
the driver circuit outputs the drive signal which includes the first polarity and which drives a first subpixel to a distribution unit corresponding with a subpixel group including the first subpixel, and outputs the drive signal which includes the second polarity and which drives a second subpixel to a distribution unit corresponding with a subpixel group including the second subpixel adjacent to the first subpixel.

13. The display apparatus according to claim 2, wherein
the subpixel group includes first to fourth subpixels respectively included in first to fourth main pixels, the first to fourth main pixels being arrayed every other, the first to fourth subpixels being subpixels having a same color to which drive signals of a same polarity are input, and
the distribution unit corresponding with the subpixel group distributes drive signals, which are sequentially input, to the first subpixel to the fourth subpixel in sequence.

14. The display apparatus according to claim 13, further comprising a control circuit configured to generate a j-th control signal (j is an integer of 1, 2, 3 or 4) to control the demultiplexer, and sequentially to output the j-th control signals to the demultiplexer,
wherein the distribution unit distributes a drive signal to drive a j-th subpixel to the j-th subpixel in response to the j-th control signal.
